(19) United States
(12) Patent Application Publication
(10) Pub. No.: US 2021/0081566 A1
(43) Pub. Date: Mar. 18, 2021

(54) DEVICE, PROCESS AND SYSTEM FOR RISK MITIGATION

(71) Applicant: Red Marker Pty Ltd, Sydney (AU)

(72) Inventors: Julian Broudou, Sydney (AU); Matthew Symons, Mosman (AU); Amanda Jan Robyn Symons, Mosman (AU)

(21) Appl. No.: 17/013,443

(22) Filed: Sep. 4, 2020

Related U.S. Application Data
(63) Continuation-in-part of application No. 15/140,929, filed on Apr. 28, 2016, now abandoned.

(30) Foreign Application Priority Data
Apr. 28, 2015 (AU) 2015901550
Apr. 26, 2016 (AU) 2016901536

(51) Int. Cl. G06F 21/62; G06K 9/00; G06N 5/02

(52) U.S. Cl. CPC G06F 21/6254; G06N 5/022; G06K 9/00469; G06K 9/00456

(57) ABSTRACT

A system for a computer useable medium, the system having a set of executable code is provided including a first set of computer program code adapted to receive at least a portion of a document comprising at least one classifiable distinct marker, a second set of computer program code adapted to analyze the distinct marker and assign a classifier thereto, and a third set of computer program code adapted to assess the potential risk of the distinct marker and calculate a first risk value associated with the distinct marker as it relates to the classifier and display the first risk value to a user of the system.

### CROSS-REFERENCE TO RELATED APPLICATIONS

This application is a continuation-in-part application of U.S. application Ser. No. 15/140,929, entitled Device, Process and System for Risk Mitigation, filed on Apr. 28, 2016, pending, which claims foreign priority to Australian Provisional Application Nos. AU 2015901550, filed on Apr. 28, 2015, and AU 2016901536, filed on Apr. 26, 2016, the disclosures of which are incorporated herein by reference in their entirety.

### TECHNICAL FIELD

The present invention relates to a device, process and system for mitigating risk by determining compliance with predetermined regulations or rules. More particularly, the system may provide a risk assessment based on whether predetermined regulations or rules are violated.

### BACKGROUND

Professional services industries have long provided letters of advice, either in hard copy or electronic format, assessments or other guidance documentation to clients or persons. More recently professional services have started to use web based posting, such as social media to expand their businesses. Commonly, these professionally drafted documents may need to conform to prescribed regulations or rules, such as internal office standards or jurisdictional legislation. While a significant number of professional services are required to maintain a number of continuing professional education (CPE), continuing legal education or other forms of continued education, a professional may still provide advice or draft a document which may not comply with industry regulations or mandatory rules. Professional industries may include, for example; lawyers, accountants, financial planners, tax agents, financial advisors, architects, auditors, engineers, doctors or specialist business service providers.

Supervised Automatic Classification (SAC) is a machine learning technique, commonly used for creating a function or classifier from training data. There are two stages that are employed by this type of machine learning. The first stage is the learning stage in which the technique extracts a characteristic word from a predetermined document or source, which has been manually classified in advance. The learning stage generates and associates at least one predetermined threshold or rule used for calculating a relevant score for predetermined categories by using a known statistical method, and stores the predetermined threshold or rule in the machine learning knowledge base. The second step is an execution stage in which SAC extracts a characteristic word from a document being classified by the machine learning system and calculates a score determined by the predetermined thresholds or rules to correctly select the most relevant category for the document being analyzed.

Known methods include binary classification approaches, for example, a Naïve Bayes approach, the Support Vector Machines technique, which can classify a document into categories and determine whether or not the document should be included in a category. Supervised Automatic Classification also includes non-binary entire classification approaches, such as the Neural Network approach, the Bayesian network technique, which can classify a document into all categories at the same time.

While the use of multiple-category classification is known in the art, there are a number of problems with correctly classifying a document using the multiple-category classification technique. Current machine learning systems may not be able to predict, offer amendment advice or otherwise assist with producing a document which is generally in compliance with a prescribed set of rules or regulations.

Further, there may be a need to ensure that professional personal advice and professional general advice are clearly differentiated such that the risk for a person or company may be reduced or mitigated.

Any discussion of the prior art throughout the specification should in no way be considered as an admission that such prior art is widely known or forms part of common general knowledge in the field.

### SUMMARY OF THE INVENTION

### Problems to be Solved

The present invention may provide a device, process or system for determining the risk of a document.

The present invention may provide a device, process or system for improving a document's readability.

The present invention may provide a device, process or system suitable for determining compliance with at least one predetermined act, regulation, policy, guideline or other standards document.

The present invention may provide an improved device, process or system for assessing the risk of at least a portion of a document.

The present invention may provide a device, process or system with improved machine learning for risk analysis.

It is an object of the present invention to overcome or ameliorate at least one of the disadvantages of the prior art, or to provide a useful alternative.

### Means for Solving the Problem

A first aspect of the present invention may relate to a system for mitigating risk, the system may comprise the steps of; analyzing a portion of a document; comparing the analyzed portion of the document to at least one predetermined classifier; the predetermined classifier associated with at least one rule; at least one risk value may be assigned to the portion of the document based on whether the at least one rule has been triggered; and wherein the system may ascertain whether the document contains non-compliant text.

The document may comprise at least one distinct marker such that at least one classifier can be associated with each distinct marker if the distinct marker is classifiable. Preferably, an independent risk value may be associated with each classified distinct marker. At least two distinct markers may be associated such that they form a couple marker or a group marker which may modify the independent risk values of each of the classified distinct markers in the couple marker or group marker. The at least one risk value may be displayed on a display to a user of the system. The at least one risk value may indicate whether a predetermined threshold of rules have been triggered for a classifier. The risk value may be determined in part by the classifier associated with the distinct marker and whether the information may be one of personal advice, general advice, a general statement, contains complex terms and jargon, or a specialized professional statement. The system may be adapted to learn and store new classifiers and rules in a knowledge base based on analyzing at least a portion of a document. Each risk value assigned to the portion of the document may determine a risk score of the document. The system may determine compliance of a document to at least one of a company policy, a guideline, a set of rules and predetermined jurisdictional legislature.

According to another aspect of the present invention there may be provided a system for a computer useable medium, the system having a set of executable code may comprise: a first set of computer program code adapted to receive at least a portion of a document comprising at least one classifiable distinct marker; a second set of computer program code adapted to analyse the distinct marker and associate a classifier thereto; and wherein a third set of computer program code may be adapted to assess the potential risk of the distinct marker and calculate a first risk value associated with the distinct marker as it relates to the classifier and may display the first risk value to a user of the system.

The risk value may be determined in part by at least one rule associated with the classifier. The risk value may be determined in part by the classifier associated with the distinct marker and whether the information is one of personal advice, general advice, a general statement, contains complex terms and jargon, or a specialized professional statement.

A fourth set of computer program code may be adapted to process the portion of the document to identify at least one of embedded metadata or other descriptors, process text, words, phrases and replace personal information contained therein with generic or randomized personal information. The document may be selected from the group of: a newspaper article, a social media post, a video recording, audio recording, a professional document, a letter, an email, a record, a register, a report, a log, a chronicle, a file, an advertisement, an internet webpage, a forum post, instant messaging, an archive or a catalogue.

The distinct markers of the document may be uploaded to a knowledge base of the system. The system may determine whether the first risk value of a distinct marker is acceptable or unacceptable, such that if an unacceptable first risk value is calculated the system issues an alert. The alert may provide at least one suggestion to a user of the system to amend at least one distinct marker such that a second risk value can be calculated for the at least one distinct marker to modify the potential risk value if an amendment is made to at least one distinct marker. The portion of the document may comprise at least a first distinct marker and a second distinct marker, each of the first and the second distinct markers having an independent risk value assigned thereto, and wherein the first and the second distinct markers are associated by the system as a couple marker. The couple marker may have a couple risk value which is determined in part by the independent risk values of the first and second distinct markers.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 illustrates a flow chart of an embodiment of a method for calculating a risk value of the system;

FIG. 2 illustrates a flow chart of an embodiment of machine learning based on user input or user feedback;

FIG. 3 illustrates a flowchart of an embodiment of digital mapping for a user;

FIG. 4 illustrates an embodiment of flowchart of an embodiment of digital mapping process;

FIG. 5 illustrates a flowchart of an embodiment of workflow of external content;

FIG. 6 illustrates an embodiment of the of the workflow for content;

FIG. 7A illustrates a first half of a flowchart of an embodiment of the system of the present disclosure;

FIG. 7B illustrates a second half of a flowchart of an embodiment of the system of the present disclosure;

FIG. 8A illustrates a first half of a flowchart of an embodiment for generating new rules or detection data for storage in a database; and

FIG. 8B illustrates a second half of a flowchart of an embodiment for generating new rules or detection data for storage in a database.

### DETAILED DESCRIPTION

In this specification the following terms may generally mean:

Distinct marker: a term, a word type, a word or term co-occurrence, word frequency, non-compliant text, a string or an array of words, a phrase, industry jargon, a new sentence, a paragraph, a symbol (such as a hashtag or monetary symbol), a predetermined number of characters, a predetermined number of words or any other predetermined marker.

Document: a newspaper article, a social media post, a video recording, audio recording, a professional document, a letter, an email, a record, a register, a newspaper, an update, a blog, a report, a log, a chronicle, a file, an advertisement, an internet webpage, a forum post, instant messaging, an archive or a catalogue or any other document which may be adapted to be read or assessed by the system.

Classifier: a predetermined category which may be associated with at least one distinct marker based on the key terms, phrases or other predetermined text or symbols of the distinct marker.

Rule: a classifier may be associated with a rule. A rule may be triggered or breached if a distinct marker contains a predefined trigger. A rule may be assigned or associated with a severity, such that when triggered a predetermined risk value is automatically assigned.

Risk Value: Based on the number of rules which have been triggered or the severity of the rules triggered, at least one of a numerical value and a word value is assigned to a discrete marker which has been classified.

Risk Score: A final potential risk assessment value, after any manipulation, factoring or weighting to a risk value, given to at least a portion of a document. The risk score can be a single risk assessment value for a document or a risk assessment value for each category type or each type of advice (such as personal advice, general advice or a general statement, for example).

Preferred embodiments of the invention will now be described with reference to the accompanying drawings and non-limiting examples. The present invention may be directed to a method, a system or a computer-readable medium encoded with a computer program for multiple-category classification using a non-binary classification approach which may not require generation of extra parameters in the execution stage. The present invention may comprise at least one of hardware and/or software component.

It will be appreciated that the present invention may be a system, and more particularly a system for use with as a computer program accessible from an electronic device, such as a laptop, mobile phone or any other device that can contain, store, communicate, propagate, or transport a program for use by or in connection with an instruction execution system, an apparatus or another device. The system of the present invention may optionally be used in combination or integrated with other third party software or systems.

The system may be used to assess the potential risk of a document, or a portion of a document based on at least one triggered rule with reference to a symbol(s) or piece of text contained within the document. The system may be used to reduce the potential risk or ameliorate a potential risk that a document may contain or disclose. The system may be configured to determine whether a portion of a document comprises at least one of the following; personal advice, general advice, a general statement, a boilerplate or generic statement, a company standard, a disclaimer or other predetermined category of text. The system may be further configured to determine whether there is a reasonable likelihood that a portion of the document is misleading, contains jargon or complex industry terms or whether the document complies with at least one set of standards or regulatory rules. It will be appreciated that the terms “risk” and “potential risk” are used interchangeably.

In a first aspect of the present invention, a system may be adapted to analyse at least a portion of a document, and more preferably analyse at least a portion of a document such that at least one risk value may be determined for at least a portion of a document. The risk value of a portion of a document may be determined by comparing the analyzed portion of the document with classifiers stored in a knowledge base, each classifier may be associated with at least one associated rule, such that a portion of a document is assigned at least one classifier. The rules may be applied to the at least one classifier and assign a risk value thereto based on whether a predetermined rule or number or rules have been triggered or breached. Preferably, the classifiers split up the document into distinct markers such that each distinct marker may have at least one classifier assigned thereto. A distinct marker may be defined by a term, a string or an array of words, a phrase, industry jargon, a new sentence, a paragraph, a symbol (such as a hashtag or monetary symbol), a predetermined number of characters, a predetermined number of words or any other predetermined marker. Assigning a risk value to a distinct marker may assist a user to identify distinct markers which may have a relatively high or unacceptable risk for the user or a company. Reducing the overall risk may increase compliance with industry regulations or best practices.

In the context of the present invention, a document may be any piece of written, printed, or electronic matter that may convey information or that serves as an official record. This may include, for example, a newspaper article, a social media post, a video recording, audio, a professional document, a letter, an email, a record, a register, a newspaper, an update, a blog, a report, a log, a chronicle, a file, an advertisement, an internet webpage, a forum post, instant messaging, an archive or a catalogue. It will be appreciated that documents for use with the present invention may include images, such as photographs, graphs, flow charts or any medium which may convey information.

A classifier may be used to analyse a portion of a document and a risk value may be assigned by assessing the analyzed portion of the document based on the classifier and comparing the assessed portion of the document to at least one predetermined rule associated with the classifier. At least one predetermined rule may be generated in accordance with, for example, jurisdictional legislation, a legislative Act, legislative Regulations, policies company guidelines, company procedures or another set of rules, regulations or any other guidelines in which an author of said document must comply with to be within the jurisdictional laws or predetermined guidelines. A predetermined rule may also be assigned or associated by a user or a company to generate an augmented risk value for a distinct marker or final risk score for a document.

In a preferred embodiment, the system may be adapted for use with the Australian Securities & Investments Commission (ASIC) Regulatory Guide 234 as of 12 Nov. 2012, Advertising financial products and services (including credit): Good practice guidance. It will be appreciated that all future versions of the Regulatory Guide may be compatible with at least one embodiment of the present invention. It will be appreciated that while legislature or rules may change, for example, due to an amendment to a guide, policy or Act, the device, process or system of the present invention may be adapted or dynamically adapt to the amendments of the legislative Act and generate at least one new classifier or rule based on the amendments. Optionally, the at least one generated new rule or classifier may be compared with previously existing rules and a determination of whether the new rule or classifier conflicts with other previously existing rules or classifiers, respectively.

Consumers may be heavily influenced by advertisements for products and services, such as professional services, when making decisions and seeking advice, particularly financial advice. The ASIC Regulatory Guide 234 may provide good practice guidance to help professionals and companies to comply with their legal obligations and potentially avoid false or misleading statements or engage in misleading or deceptive conduct. The ASIC guidance may apply to any communication intended to advertise financial products, financial advice services, credit products or credit services. The ASIC Regulatory Guide may encourage industry bodies to develop guidelines, standards or codes based on good practice guidance and may encourage industry bodies to respond to specific needs of the sector. While the primary responsibility for advertising material rests with the organization placing the advertisement, publishers and media outlets may also have some responsibility for content. The present invention may assist with companies, individuals and industry bodies to comply with these regulatory guidelines.

If a conflict between a new rule or classifier and at least one previously existing rule or classifier is determined, an alert may be issued to a user or operator of the system such that a new compliance threshold may be created based on the determined conflict. The alert may be one of a sound, a message, an email or any other predetermined message displayed to alert a user of the system.

In at least one embodiment, between one to seven predetermined rules may be used to determine the potential risk of at least a portion of a document. These rules are preferably professional rules which may be suitable for professional industries such as legal, financial, medical, engineering or any other profession that must adhere to at least one governmental policy or company policy. Examples of classifiers which may be used with the present invention may be: “Returns, features, benefits and risks”, “Warnings, disclaimers, qualifications and fine print”, “Fees and costs”, “Comparisons”, “Past performance and forecasts”, “Use of certain terms and phrases”, “Target audience”, “Endorsements and testimonials”, “Personal advice and product references” and “General advice”. It will be appreciated that rule names may be changed or other rules may be used for a particular industry and are not limited to the above list of rules.

It will be appreciated that not all documents analyzed or assessed by the present invention will need to comply with all or any of the above predetermined classifiers or classifier rules, as a document may be outside of the guideline requirements for risk assessment, for example, an internal company memo, a private message or a confidential piece of information may be excluded from being analyzed. An identifier may be assigned to a document to direct the system to ignore portions or the entire document to be excluded from analysis. For example, the term “privileged and confidential” or “memo” may indicate to the system that an analysis is not to be conducted or a user may manually indicate that a document or portion thereof is not to be assessed. Alternatively, the system may determine that the document being analyzed does not fall within any predetermined classifiers and therefore as no classifiers have been assigned no rules may be triggered and the document does not need to be assessed by the system. However, the user may optionally direct the system to complete an assessment and manually assign predetermined classifiers. If no assessment is generated for a portion of a document the risk value is indicative of a non-applicable score.

In at least one embodiment of the present invention, a risk value may be a percentage such that a score of 100% or higher is a certain risk and a score of 0% or lower will indicate a negligible or non-existent risk for the document, for example. The risk value may indicate in the simplest form whether or not an analyzed portion of a document will have a high risk or a low risk. For example, if the risk value is above 50% the portion of the document assessed may be considered to have a high risk, or if the risk value is below 50% the document may be considered to be a low risk. However, it will be appreciated that any number of risk parameters may be used to illustrate varying levels of risk. For example, if five risk parameters are used, they may be between predetermined integers or fractions thereof, such as 0-20% (very low risk), 20-40% (low risk), 40-60% (moderate risk), 60-80% (high risk) and 80-100% (very high risk). These risk ranges and risk assessment titles (i.e. low risk, high risk, etc.) are for illustrative purposes only and are not intended to be limiting. As such, it will be understood that any number or range set may be used to define a predetermined risk or feature of at least a portion of a document.

The system may be comprised of two stages a learning stage 200 and an execution stage 100. In the learning stage 200 the system may be configured to determine, receive, be in communication with or otherwise compile a knowledge base, based on document samples and/or samples from a predetermined act, regulation, guideline or other training document. A portion of a document may be analyzed to determine text or images which may convey information. The information may then be interpreted by the system with reference to at least one of a thesaurus, a dictionary, a predictive text algorithm, knowledge base, data set, sample document or other user samples or rules. As classifiers are assigned samples for the system to learn from, the classifier learning stage 200 uses the information to learn which terms, symbols, phrases, distinct markers or other characteristics are generally associated with a classifier or classifier rule. Therefore, an association may be made between a rule and at least one characteristic of a document such that a rule can be triggered if a characteristic breaches at least one rule or breaches a predetermined threshold.

The knowledge base of the system may preferably be compiled from a learning document comprising at least one of; jurisdictional legislation, a legislative Act, legislative Regulations, company policies, company procedures or another set of rules, regulations or any other guidelines. Distinct markers may be extracted from the training documents and transformed such that the learning stage of the system may read or otherwise interpret the training documents without significant intervention from a user or system administrator. The distinct markers extracted may then be identified by the system and classified based on the predetermined classifiers. The system may then assess whether any rules which the classifier is associated with have been triggered or breached by the distinct marker such that if the system detects a particular term, phrase, string or an array of words or other breach of a rule the document may assign a risk value to the distinct marker. The association between the distinct markers and the classifiers may be stored in the knowledge base for use in the execution stage 100.

In at least one embodiment the knowledge base may be stored on a computer readable medium, such as magnetic disks, cards, tapes and drums, punched cards and paper tapes, optical disks, barcodes, magnetic ink characters, solid state drives or a cloud. Preferably, the knowledge base may be adapted to learn from new documents assessed by the system and update the rules according to user feedback, input or approval (210). The feedback may then be aggregated (220) and training samples (230) may be used in combination with the machine learning of the system (240). The samples may teach the system at least one of a new classifier, a new rule or may update existing rules and classifiers to provide an improved degree of certainty. Classifiers and rules may be stored, for example, in a cloud, on a hard drive, a solid state drive or any other computer readable medium.

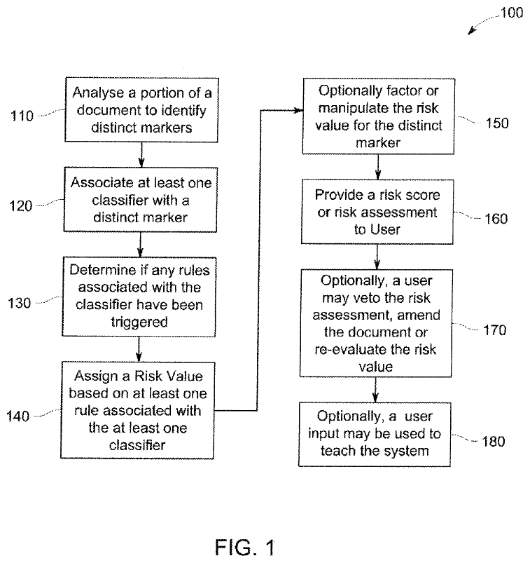

Once the system is able to analyse and assess a document with a sufficient degree of certainty, the system may move to the execution stage 100. With reference to FIG. 1, the execution stage 100 of the system may comprise the following steps:

Step 1 (110): Analyse a portion of a document with reference to the knowledge base.

Step 2 (120): Assign at least one classifier to at least a portion or a section of the document, preferably a distinct marker. Each classifier may be associated with a predetermined number of rules.

Step 3 (130): Assess each section of the document based on the at least one classifier associated with at least one distinct marker and determine if any rules have been triggered. Each section may comprise at least one distinct marker such that a risk assessment may be assigned thereto.

Step 4 (140): Assign at least one risk value based on at least one rule of the at least one classifier to each distinct marker of the section.

Step 5 (150): Determine if at least two distinct markers fall within a marker group or are a coupled marker, and optionally factor or manipulate the marker group or coupled marker based on predetermined or dynamic factors.

Step 6 (160): Provide a risk assessment of each distinct marker or marker group to the user identifying any risks or providing any other predetermined message to a user for review. A risk score may be provided as part of the assessment.

Step 7 (170): A user may determine whether to veto or make modifications to a document to either bring it into compliance or ensure that the portion of the document assessed has a low or very low risk.

Step 8 (180): The document or user input may optionally be used to teach the system.

Post execution stage, a user with sufficient privileges may veto the risk assessment of the system. If a user modifies or vetoes the risk assessment, the data may be uploaded to the knowledge base to modify classifiers or factor rules or risk values. Optionally, if a user modifies or vetoes a risk assessment a message may be sent to a manager or system operator notifying them of the modification or veto. Preferably, a veto or a modification may be conducted after the risk score has been applied to a document and may optionally be performed by another user of the system.

It will be appreciated that not all steps supra may be required for the system of the present invention. It will further be appreciated that the system of the present invention may comprise alternate or further steps, references or weighting factors. The steps above may be optional such that some steps may be skipped by the system.

In the execution stage 100 the system may analyse at least a portion of a document and assess the portion of the document with respect to the knowledge base. As the portion of the document is analyzed, the system may split up or identify distinct markers to which at least one classifier may be associated with respect to the information stored knowledge base. Optionally, the stored knowledge base may also have reference to a dictionary, a thesaurus, the Internet or any other reference data set. Once the distinctive markers have been analyzed, the system determines whether any or all of the rules, to which a classifier is associated, have been triggered or breached. Preferably, a predetermined threshold may be exceeded to define whether a rule has been breached or triggered and a risk value may reflect whether the predetermined threshold increases a base risk value based on the context of the breach. A risk value may then be assigned to a portion of a document based on the triggered rules and the context of the distinct marker. For example, a low risk may be assigned to a distinct marker such as “financial consultations are charged at an hourly rate” and a moderate to high risk may be assigned to a distinct marker such as “financial consultations may be charged at an hourly rate”. This may be due to the uncertainty regarding the distinct marker between the words “are” and “may” and the potential to mislead consumers or readers of the document.

While a distinctive marker may be used to determine a risk value, it will be appreciated that two distinctive markers may respectively negate each other, may factor each other, or otherwise be manipulated to form a risk value based on the two distinctive markers. For example, if a document discloses a first distinctive marker that has a fee or cost which may be payable, and has a risk value of 40% assigned thereto, and a second distinctive marker, such as a disclaimer, which discloses the exceptions to the fee or cost, and has a risk value of 20%, the two may be interpreted to be a coupled marker, or group marker if more than two distinct markers are interpreted to be associated, and have a combined risk value of less than 40%, for example, as the disclaimer may reduce the risk value of the fee or cost distinct marker. In at least one embodiment, coupled markers or group markers may factor a risk value such that negative or high risk distinct markers provide a risk value which is multiplied or otherwise manipulated by a predetermined factor to produce a higher risk value than either distinctive marker alone, or vice versa. In yet another embodiment, a negative (high risk) and a positive (low risk) risk value may be a coupled marker which produces a risk value between the negative and the positive risk values. It will be appreciated that the risk values may be manipulated or factored by any predetermined value or method.

In another embodiment, the system may detect the proximity of a distinct marker relative to another distinct marker. For example, the first marker may be a testimonial or personal statement and the second marker may be a name or identifier of a person or company in relation to the testimonial. This allows the system to assess whether two distinct markers are too close in proximity, if two distinct markers are too far apart respectively or if a second distinct marker is not found within the portion of the document which must qualify or otherwise validate a first marker in analyzed portion of the document. For example, if a first distinct marker contains the term “see terms and conditions” and a second distinct marker is not found which provides the terms and conditions, a high risk value may be assigned to the first distinct marker to notify a user of the absence of the second distinct marker.

Further, the system may be configured to provide a blacklist or exclusion list of symbols or terms for a document based if a predetermined classifier is associated with at least one distinct marker or if a predetermined rule is triggered. For example, if a term or symbol from the blacklist is detected by the system, a risk value may be applied to the blacklist term which indicates a high or unacceptable risk value.

In at least one embodiment, a blacklist term or symbol may be assigned a lower risk value or may not be considered a blacklist term or symbol if a qualifier distinct marker is found which relates to the blacklist term. For example, if the term “up to” or “from” is applied to a “fee or cost” classifier of a product or service, a distinct marker defining the limitations or circumstances in which the “up to” or “from” fee or cost is allowable, may reduce the risk value of the term and may make the term allowable.

Alternatively, a term may become a blacklist term based on a distinct marker. For example, if the term “free” is used and at least one fee or charge is found to be associated with the term “free” a high risk value may be assigned to the use of the term “free” as this may provide incorrect information or misleading information.

In a further embodiment, the system may determine the prominence or placement of a first distinct marker, relative to a second distinct marker found within the section of the document. This may allow a user of the system to correctly place the distinct markers in the document to adhere to predetermined regulations or rules.

While the system may analyse and assess at least a portion of a document and determine whether distinct markers fall into a distinct marker group or are couple markers, a user of the system may optionally link distinct markers to ensure risk value is assigned to a desired distinct marker group or couple. This may allow a user to reduce the overall risk score of a document if the system incorrectly associates distinct markers.

Where reference is made to two distinct markers, it will be appreciated that any number of distinct markers may be grouped or otherwise associated together, such that a risk value may be assigned based on the assessment of the group of distinct markers. In at least one embodiment, the rules of a classifier may be mutually exclusive, or vice versa.

In at least one embodiment, the classifiers may be selected from at least one of the following group; alternative-strategy, benefit, compliance, conditions-apply, credit-assistance, disclaimer, discount, fees, forecast, forecast-disclaimer, general advice disclaimer, general-advice, general-advice-short, jobs, news, past-returns, past-returns-short, personal-advice, personal advice disclaimer, privacy policy disclaimer, product, product-award, product-rationale, promotion, promotion-short, returns, returns-risk, returns-short, scenario, spam, term list, testimonials, and unbalanced.

The machine learning algorithms of the system may be used to “train” or “teach” the classifiers stored in the knowledge base and may be able to predict whether a new or never-before-seen distinct marker corresponds to a classifier already stored in the knowledge base. If a never-before-seen distinct marker is detected, a user may optionally associate a classifier or create a new classifier based on existing classifiers or otherwise create an entirely new classifier which may be configured to adopt rules which are associated with existing classifiers.

In one example, the classifier “Returns, features, benefits and risks” may determine whether all necessary information is disclosed within a document. In this example, if the document disclosed only the benefits and advantages of an investment without the risks or disadvantages of the investment, the system may issue an alert to the user to notify them of a potential high risk or of non-compliance with a regulation or rule.

A classifier may be for example at least one of the following group: alternative-strategy, benefit, compliance, conditions-apply, credit-assistance, disclaimer, discount, fees, forecast, forecast-disclaimer, general advice-disclaimer, general-advice, general-advice-short, jobs, news, past-returns, past-returns-short, personal-advice, pp-disclaimer, product, product-award, product-rationale, promotion, promotion-short, returns, returns-risk, returns-short, scenario, spam, term list, testimonials, unbalanced. The classifiers are preferably defined by the training documents or assigned by a user, for example a legislative act or a policy, however the classifiers may also be manually configured for the system and be independent of the rules. A user may optionally elect to turn off or exclude classifiers from being assigned to a document.

However, it will be appreciated that the classifiers may be independent of the learning documents and at least one rule for the classifiers may correspond to at least one of the learning documents. This is to say that the rules for the classifier may be independent of the classifier to improve a final risk assessment value.

For example, rules for the classifier “returns” may be able to be restricted to only detect text or symbols that mention returns, profits, gains or the like, as opposed to a larger detection of returns which may be used in the context promotion or offering an opinion classifier. The determination of classifiers may be based on samples of text in reference to at least one distinctive marker and the number of triggered rules to which the classifiers have been associated. An assessment of the number of triggered rules may result in a classifier being split into more than one classifier if the number of triggered rules is above a predetermined threshold. The system may then determine which triggered rules have similar or common attributes to define at least one new classifier for the system. In at least one embodiment, at least 32 rules may be chained together and used as preconditions or predetermined thresholds for assigning a risk value. This is advantageous as this allows for a greater degree of certainty with respect to the correct triggering of rules. The use of fewer than around 20 preconditions may result in rules being incorrectly triggered or otherwise classifiers being incorrectly assigned.

In at least one embodiment, at least one of the classifiers or associated rules may have a pre-defined filter which may allow for an improved risk assessment of the portion of the document. The filters may be able to detect edge cases or outliers which may be uncommon for a particular classifier based on the at least one filter. For example, if the system detects a section of text within a portion of a document does not fall into a classifier related to other classifiers associated with other distinct markers, the system may flag the section of text for manual classification or otherwise assign a classification which has a lower degree of certainty.

An advantage of applying filters to a rule may allow the system to be more easily trained and may allow smaller samples which define rules to be added to the knowledge base of the system. Using this method may allow the system to trigger rules more correctly or with a higher degree of certainty based on the attributes of the classifier. For example, the classifier “returns” may be assessed with respect to key terms or phrases rather than text samples that exhibit all of the attributes of the classifier rules. This may also allow the system or the end user via a user interface to create a new rule by chaining a plurality of classifiers and filters together.

To simplify the end result to a user, the risk value of the assessed document may be provided as a relative risk score. Preferably, the risk score is on a scale from 0 to 5 for each triggered rule and a color code each triggered rule may be more easily recognized by a user.

Generally, a risk value may be calculated and assigned after at least a portion of a document has been analyzed and assessed by the system. In this example, the document is a text based document, such as a promotional/advertorial text, social media updates, forum or blog posts, Electronic mail, transcriptions of videos or extracts from documents such as power point presentations, pdfs, word document or any other text document.

Optionally, the purpose of the text may be manually assigned to reduce the number of potential classifiers being assigned to the portion of the document. The purpose of the text may be, for example, a status update, a promotion, an advertisement, a blog post or any other predetermined type of document.

The user may also select the platform in which the document is to be published, for example a YouTube video, a social media website, a newspaper or any other suitable location for information to be displayed. In the case of a video, such as a YouTube video, at least one of the audio stream and the visual stream may be assessed for potential risk. Preferably, the audio stream and the video are split into the respective audio stream and visual stream where each stream may be assessed. The visual stream may be divided into frames or stills which may then be analyzed for potential risk. For example, the present invention may search the stills for symbols or terms such as “free” or “no repayments”, or any other predetermined features. The audio stream may be analyzed for key terms or other personal or professional advice terms. It will be appreciated that the terms “audio stream” and “audio recording” may be used interchangeably.

The user of the system may also have a user profile which may contain a number of restrictions, authorizations, past history, company profile or any other predetermined limitation. The user profile may have risk modifier values assigned thereto based on past usage of the system, industry experience or any other predetermined quality. If a company of the user is also identified within the profile and additional pre-set of rules may be applied to the document to be used in the risk assessment.

Using the above inputs are entered into the system, the rules relevant to the portion of the document being analyzed are retrieved. The rules may be regulatory/compliance rules, branding rules, profanity/spam and comprise at least one associated classifier. Each of the rules may be associated with a number of preconditions, a baseline risk score and a baseline confidence score. Preferably, the baseline risk score may be a value between 0 to 10, or more preferably is a value between 1 to 3, and the baseline confidence score may be between 0 to 20, or more preferably the baseline confidence score is between 1 to 5.

The rules are used to determine the risk value of a distinct marker, such that if the classifier is associated with at least one triggered rule the risk value may be higher than if no rules are triggered. For a rule to be triggered, a predetermined threshold must be exceeded or otherwise not be satisfied. A predetermined threshold may comprise the classification or non-classification of text using machine learning models, such as linear regression or support vector machines, for example. A further predetermined threshold may comprise the presence of part of speech (POS) tags and certain character classes, such as a specific currency or time period. Other predetermined thresholds may be the presence of absence of trigger or blacklist terms or phrases, text length, the number of ambiguous terms, the use of personal advice or how colloquial the language of the document may be. It will be appreciated that the other predetermined thresholds, not listed, may be suitable for use with the system of the present invention.

The portion of the text may be analyzed and split up into distinct markers based on at least one classifier, in which at least one classifier may be associated with a distinct marker. The distinct markers in this example may be split up into grammatical structures and lexical models, or distinct markers. The distinct markers may be associated with a classifier based on the terms used and the sequence of words.

Based on the analysis of each distinct marker, the system may then determine whether all or any of the predetermined thresholds have been satisfied. If all of the predetermined thresholds have been satisfied an associated rule may be triggered. Optionally, additional filters may be applied to the triggered rule to reduce or increase the risk value associated with the distinct marker. In at least one embodiment, the filters may ignore some triggered rules. For example, if the text classified is ‘personal advice’ but the distinct marker is less than 50 characters in length, the system may determine that this is not personal advice and the system may not issue a message or assign an adverse risk value to the distinct marker.

In a preferred embodiment, the calculation of the risk value may be assessed using at least one of a rule's base line risk score and confidence score. Optionally, a factor or other manipulation of the risk value associated with a distinct marker may be factored or otherwise manipulated. The risk value may increase or decrease in severity based on the terms or phrases within the distinct marker. A factor or manipulation of the risk value may also be based on the user profile, such as the time spent as a user of the system, a number of prior infringements, a user's authorizations and licenses, or any other data set assigned to a user or a company of a user may be used to apply additional factors or weightings to the risk value.

Optionally, the confidence score may also be factored to improve the final risk assessment value issued to a user. For example, a factor may be applied based on; a probability that the text has been correctly classified, a proportion of certain POS tags relative to the length of the text, or any other parameter.

A highest risk value based on the rules that were triggered may then be used to determine the overall risk score of the document. Optionally, the risk scores are color coded such that a user may easily identify the risk of each distinct marker. The color coding may represent the assessments of risk at a rule level, or optionally as an entire document. In at least one embodiment if no rules are triggered then the text will be assigned a risk score reflecting a non-assessment or a score which represents that no rules were triggered.

In a preferred embodiment, a score of 0=Nothing Detected, 1=Low Risk, 2=Low-Medium Risk, 3=Medium Risk, 4=High Risk, 5=Higher Risk. The system may assign a regulatory rule a risk rating of 1=“Low”, 2=Moderate or 3=High based on the risk associated with breaching the rule. It will be appreciated that other integers or scores may be used to assign a risk rating. The risk rating may be based on a number of criteria including the nature of the rule and extent of the penalty, such as an indictable offence or a monetary penalty. When analyzing a portion of a document or a distinct marker, the system may factor or modify this rating based on the content of the portion of the document to provide a more specific indication of the extent of the risk. A degree of risk rating may be based on at least one of the risk value and the risk rating.

The degree of confidence may be reflected by a confidence rating associated with the rule of a distinct marker. This degree of confidence may reflect whether the likelihood of whether a triggered rule has been triggered correctly. When analyzing a portion of a document, may refine this rating based on the content of the portion of a document to give a more specific indication of its confidence that it has correctly triggered a rule. For example, the system may cross reference the triggered rule with respect to a tangible reference, such as the absence of a general advice warning. In this example, if there is no general advice warning provided, or if there is no disclosure of a warning about past performance being no indication of future returns in a statement about returns, its confidence will be higher than if a past performance warning was provided. A degree of confidence rating may be based on at least one of a risk value and the degree of confidence.

A risk value may be dependent on the rule triggered with respect to the degree of confidence rating. If a rule is likely to have been triggered a factor may be applied to the risk value based on the company profile or the user profile associated with the assessment of the portion of the document. This allows companies or users to apply their own risk thresholds to produce the final risk value.

The final risk value produced by the system may optionally assist the user in identifying the highest risk sections of the portion of the document and may offer suggestions with respect to amending the document to reduce the risk or bringing the document into compliance with, for example, a particular Act or Regulation.

For example, if a user has used the term “baby wraps”, which is a complex financial product, the system may issue an alert to the user that industry concepts or jargon such as “baby wraps” may not be understood by customers unless they are within a particular industry. As such, the system may prompt the user to change the jargon or industry term to simplify the text for persons who may be exposed to the text if they are likely not to understand the term.

A risk matrix may also be generated by the system which may plot each triggered rule to graphically illustrate the level of risk. The risk matrix may compile the results from a number of assessed documents from a particular user or for a particular company. This may allow a graphical output which may highlight the areas of a company which are at risk of breaching particular laws, regulations or policies. A risk matrix may plot the degree of risk vs the degree of confidence. Each data point on the graph may provide additional details relevant to the risk and may offer suggestions on how to reduce a high risk area of the company.

Further, the risk value and risk matrix may allow the execution of automated actions based on the risk value and risk matrix. For example, a trigger may alert a user or flag a user for compliance education if risk scores are too high.

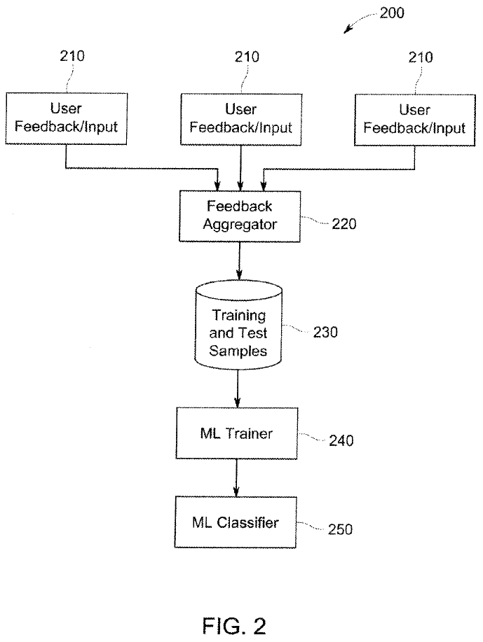

The system may optionally be adapted to learn from user feedback and adjust a risk value based on the user feedback received. This allows a risk value to be modified and increases the likelihood that a particular rule has been correctly triggered (see FIG. 2). For example, a user of the system may provide feedback or input for the system when the system has incorrectly triggered a rule or has made an incorrect assessment. An incorrect assessment may include a false trigger, or a section of text which has been assigned an incorrect classifier, a distinct marker which has not been coupled or grouped correctly with other distinct markers or a section of text which has been assigned no distinct markers. Preferably, the user of the system provides feedback through a user interface. The user interface may optionally allow for manipulation of the final risk value. Optionally, the user may be required to have permission or sufficient rights to provide feedback or input for the system.

An aggregator may then assess the user feedback or input from more than one user, users of a particular group, users from the same company, a single user or any other predetermined or random selection of users. The user feedback or input may be termed an instance and each instance may require validation from the system before being added or referred to by the knowledge base.

If an instance is uploaded to the system, preferably any personal metadata such as a user's name, company, author of the document or other predetermined metadata may be removed from the instance. This may remove any personal data from each instance. Further, if a portion of a document assessed contains any personal information such as names, addresses, phone numbers, email addresses or other identifying information, this personal information may be removed from the feedback or input samples. Preferably, any personal information may be replaced with randomized or predetermined personal information. For example, a male name may be replaced by “John Doe” and a female name may be replaced with “Jane Doe” if predetermined personal information is used. If more than one personal identifier or piece of personal information is present within the text, the system may assign a subsequent replacement identifier to maintain the coherence of the text for the system to correctly learn. Using randomized or personal information may avoid classifiers from becoming skewed and providing incorrect risk assessments.

The distinct marker classifiers are then grouped together into relevant classifier groups which may be linked or similar in nature or construction. These distinct markers may then be randomly distributed to the system to be stored into the knowledge base as a training sample or otherwise stored on a storage device for future reference by a user or the system.

The training samples may then be merged with the existing samples in the knowledge base to improve the certainty that a classifier has correctly been assigned and improve the certainty that a rule has been correctly triggered. New classifiers may also be produced which may also be associated with at least one new rule, a similar rule as that of another classifier or an identical rule as that of another classifier. The newly developed classifier may then be tested against random samples stored in the machine learning classifier to determine whether any conflicts or errors arise based on the new classifier. The new classifiers with the fewest errors or conflicts may be adapted for use with the system. In at least one embodiment, new rules may also be formed in a similar manner as that of new classifiers.

Suitable algorithms which may be used with the present invention may include: Logistic Regression, Naive Bayes, Nearest Neighbour, Inductive Logic Programming, Clustering and Representation Learning. It will be appreciated that other learning algorithms may be used with the present invention.

In addition, the present invention may also be adapted to use feature cleansing algorithms which may remove stop words, URLs and hashtags, for example. Cleansing the document of any unwanted data may reduce the time it takes to assess a portion of a document. After the document has been analyzed and cleansed the data may then be transformed into numerical and categorical data.

While these machine learning algorithms are known in the art, it is not known to use a combination of algorithms which have been adapted to receive any number of parameters, such that they may train a classifier, test the classifier and then determine the most appropriate classifier for analyzing a portion of a document.

Open source software such as python SK-Learn, python nitk and PCRE regular expression libraries, may be used with the present invention. The libraries have been adapted for use with the machine learning classifiers such that they are adapted to assess the risk value of at least a portion of a document.

In at least one embodiment, the system may further determine whether at least two isolated sections of text are providing conflicting information. This may increase the risk score of the document.

In at least one embodiment of the present invention, the risk value assigned to a document by the system may vary based on jurisdictional selections. For example, if a single document is to be issued to multiple jurisdictions an independent risk score may be assigned to the document for each jurisdiction. The system may further provide suggestions or potential amendments to reduce the risk score of the document for a particular jurisdiction or may otherwise bring the document into basic compliance for release into a jurisdiction.

In yet another embodiment of the present invention, the system may comprise a computer usable medium with at least one set of computer program code. Preferably, the system comprises a first set of computer program code which may be adapted to receive at least a portion of a document comprising at least one classifiable distinct marker. A second set of computer program code may be adapted to analyse the distinct marker and assign a classifier thereto; and wherein a third set of computer program code may be adapted to assess the potential risk of the distinct marker and calculate a first risk value associated with the distinct marker as it relates to the classifier. The first risk value may be displayed to a user of the system on a display device.

The first risk value may be determined in part by at least one rule associated with the classifier and may in part be determined by the classifier associated with the distinct marker and whether the information is one of personal advice, general advice, a general statement, contains complex terms and jargon, or a specialized professional statement.

A fourth set of computer program code may be adapted to process a portion of a document to identify at least one of embedded metadata or other descriptors, process text, words, phrases and replace personal information contained therein with generic or randomized personal information.

Preferably, a document suitable for use with the system may be selected from the group of: a newspaper article, a social media post, a video recording, audio recording, a professional document, a letter, an email, a record, a register, a report, a log, a chronicle, a file, an advertisement, an internet webpage, a forum post, instant messaging, an archive or a catalogue or any other document which may be adapted to be read or assessed by the system.

Optionally, a user may allow the document assessed by the system to be uploaded and stored by the knowledge base of the system such that the system can more easily assess and determine whether a rule has been triggered with a higher degree of certainty for further document assessments.

The system may further determine whether the first risk value of a distinct marker is acceptable or unacceptable, such that if an unacceptable first risk value is calculated the system may issue an alert to a user. If an alert is issued, the alert may provide at least one suggestion to a user of the system to amend at least one distinct marker such that a second risk value can be calculated for the at least one distinct marker to modify the potential risk value if an amendment is made to at least one distinct marker. Preferably, the system may be adapted to determine a risk value based on the target audience of the document. For example, a document containing technical jargon may be given a high risk if it is to be released to unskilled persons, such as a consumer, but the same document may be given a moderate to low risk if the document is to be released for industry persons or professionals with a greater understanding of the field.

A portion of a document may comprise at least a first distinct marker and a second distinct marker. Each of the first and the second distinct markers may have an independent risk value assigned thereto, and wherein the first and the second distinct markers are associated by the system as a couple marker. If the system detects a couple marker, the system may be adapted to assess the independent risk values of the first and second distinct markers and factor or otherwise manipulate the independent markers to form a coupled risk value which may be different from that of the independent first and second distinct risk values. The couple marker may have a couple risk value which may be determined in part by the independent risk values of the first and second distinct markers.

After a document has been assessed and a risk value has been provided to the user, the user may indicate whether they agree with the assessment of the system, particularly with any sections of text which may have triggered at least one rule. If the user agrees with the system, random samples of the portion of the document may be uploaded to the knowledge base such that the system may use the random samples to improve the accuracy of triggering rules. If the user disagrees with the system with respect to triggering a rule or the classifier associated with a distinct marker, the user may veto the system's assessment of a distinct marker. The user may optionally provide a reason or reclassify the distinct marker such that the system may optionally upload and store the user feedback in the knowledge base to provide a more accurate assessment for future analysis of documents.

The system may also be adapted to dynamically learn at least one of new rules and classifiers based on user feedback, new terms the system has never encountered or updates to the learning documents. It will be appreciated that the system may dump or otherwise ignore new rules and classifiers if they breach existing classifiers or rules, or may be adapted to ignore learned rules or classifiers if a learning document is amended. Therefore, the system may be adapted to learn from a hierarchy in which the learning documents, such as jurisdictional legislation or compulsory rules and regulations, which may provide the highest order of learning and user feedback or dynamic learning which may provide a lower order of learning. This may ensure that the system is adapted to follow industry compliance rules first and follow preferred practice secondly such that a professional may not breach a mandatory rule or guideline.

Optionally, the system may require an independent validation of user feedback to ensure correct learning of the system. Optionally, the system may test new classifiers or rules based on user feedback to determine whether they conflict with any existing rules or classifiers. Preferably, any feedback from a user is issued to the system electronically, for example via a computer type interface. Although, it will be appreciated that physical documents which are electronically readable may also be used with the present invention. In at least one embodiment, the system may optionally cross reference or having a matching association with other documents or examples previously assessed, referenced or otherwise entered into the system to assist providing at least one risk value or a final risk score. Optionally, two documents may be assessed together and may form a coupled document which may modify individual risk scores or values associated with respective documents.

In yet a further embodiment, the system may be adapted to identify and manage regulatory compliance for a published document. A published document may include at least one of; a word document, a webpage, an embedded video file, an embedded audio file, a PDF, a text document, an article, an electronic text document, a social media post, a social media platform, a letter or statement of advice, a brochure, a report, an advertisement, adwords, metadata, or any other document which contains text, numbers, images, audio and/or video. It will be appreciated that the system may be adapted to perform optical recognition for a document such that words, symbols and numbers may be converted into a digital format. Further, the system may also be adapted to convert audio and/or video to digital text to be assessed by the system. The system can be used to assess at least one data set. The document may also be an unpublished document. The published or unpublished document may be generated by a user or by a system, such as a system which automatically prepared statements of advice (which may also be referred to as a robo-advice platform or robo-advisor).

In yet another embodiment, the published documents relate to financial advice and financial services. The system is preferably adapted to increase the accuracy and/or effectiveness of advice and also to make regulation advice services more efficient. In one example, the regulation of financial service licensees may be improved by the system.

The system may comprise a plurality of system nodes which may be accessed by varying levels of users. In one example, the users may belong to the financial industry, and have levels of; financial services industry participants authorized to create content, financial services industry participants authorized to approve the publication of content, expert regulatory advisers, expert legal advisors, system administrators, system regulators or any other predetermined user. It will be appreciated that a level of user preferably relates to a level of access to the system rather than a name, as the names of users may be altered by an administrator or authorized user of the system.

The system may further be adapted to track the interactions of a user of the system during drafting, reviewing, approving and publishing content. This may allow the system to generate a user specific profile which may be able to predict and assist with compliance of a user, such that recommendations may be shown to a user to improve their skills, or build on new skills. The system may also be able to learn by the way a user drafts, such that a writing style similar to that of the user may be used with recommended text.

The system may check the compliance status of digital content against at least one rule. Compliance checks may occur regardless of the publication status, for example, the system may be adapted to determine compliance before and/or after publication such that the risk of a document is kept as low as possible.

Optionally, the system may be adapted to generate a compliance report for management based on user input data. For example, the report may flag each instance in which a user has entered non-compliant data or data which may trigger a risk warning, regardless of whether they have amended the non-compliant text. This may show management if there is a common rule being triggered across a select group of users, such as a company department, which may require additional training to reduce the potential for the non-compliant text to be generated in the first instance. A rule may also be triggered on the balance of probabilities rather than strict threshold values. The balance of probabilities may relate to the authors experience level or prior rule triggers.

In yet a further embodiment, the rules for the system are initially manually generated and may be referred to as ‘seed’ rules. The seed rules may be based on regulatory requirements, best practice standards, legislation and industry compliance rules. The system is preferably adapted to refine rules and/or generate new rules based on the actions of different users, user responses to risk notifications, comments input by users, and their status or level within the system. Data input by users may be declassified by the system for learning, such that information sent to at least one server or node of the system can categorize the data input by a user. Data input may be a comment in response to a system recommendation for example.

In yet another embodiment, the system may be adapted to run a compliance knowledge check, in which a series of statements are presented to a user and the user may identify which statements, if any, are factually correct, or if the statements require amendment. This may further provide another level of training for a user of the system.

Using Natural Language Processing (NLP), machine learning or other analytical and/or statistical approaches, the system may be adapted to suggest real-time modifications or amendments, such that non-compliant text can be rectified before a full document compliance report can be issued. The system may further be adapted to categorize, declassify and/or consolidate text (published or otherwise) that forms a test bench. The test bench data may provide the basis for checking new rules or existing rule modifications to determine whether the rule provides adequate compliance.

Preferably, the test bench is used to validate the results of modifications made to rules and the underlying classifiers that make up said rules. Optionally, the system may be used to validate new rules, if the test bench is amended to include samples that trigger the new rules.

An expert, an expert committee, a system administrator and/or a moderator may oversee the rules associated with the system. It will be appreciated that at least one user or at least one expert may be referred to herein as an expert committee. New and/or modified rules may be generated and/or tested by at least one of an expert, an expert committee, a system administrator and a moderator, in addition to, or instead of, the system being able to generate a new and/or modified rule. New rules or modifications to existing rules may improve the system's ability to detect noncompliant or high risk data. The new rules may optionally be compared with the test bench before being implemented by the system to increase the potential for the new rules to be valid and increase the potential for detection of non-compliance. In this way the system preferably allows a ‘semi-supervised’, or human moderated, machine learning and/or an ‘unsupervised’, or machine-learning based, automated learning and optimization loops.

The expert committee and/or the systems moderator oversees the system rule development by inputting new rules and/or existing rule modifications into the testing process. By reviewing the new rules or rule modifications that emerge from the system's own unsupervised learning and optimization capability, the system is provided an additional layer of certainty that rules are valid.

In one example, a user may be at least one of; a participant, an expert user, an expert committee, a system moderator, a training provider, or any other predetermined user. A participant may be a licensed entity, an authorized representative, an employee, a digital and marketing agency, an outsourced compliance provider or external lawyers, for example. Entities and individuals who are licensed to provide financial services (including individuals employed or sub-contracted by these parties) and entities and individuals who are sub-licensed to provide financial services (including those individuals employed or sub-contracted by these parties) may also be referred to as a participant.

In a further example, an expert user may be expert legal/regulatory service providers appointed by the participants to provide advice, guidance and recommendations with respect to compliance status of content via the system.

In another example, an expert committee may be a committee comprising a number of industry or compliance experts such as leading legal/regulatory experts, financial services industry body representatives, representatives from government regulatory authorities, or technology experts. In a further example, a system moderator may be a party responsible for managing and maintaining the system. In yet another example, a training provider may be a provider of regulatory compliance training and support services to participants including lawyers, consultants, training specialists, outsourced training providers, or publishing houses.

The rules of the system may also be related to at least one of; regulatory rules that reflect other relevant authorizations/licenses/approvals which may not be held by a user and hence the user should not be generating a document with respect to fields which the user or participant is not qualified to generate or comment on as they are not an industry professional or may lack the necessary skills for said field. For example, a user with an arts degree may not be qualified to provide taxation advice and therefore should not be providing tax advice in a document, or otherwise.

Other rules of the system may be business rules which adhere to the values of a company or reflect internal policies. The business rules may be generated by a participant for example, or any other user of the system with authorization to generate such rules. It will be appreciated that the regulatory rules will typically take priority over business rules, such that compliance with legislation or government requirements is more likely to be ensured when the system determines compliance of a document. The business rules may be seeded to the system and tested before implementation such that business rules can be tested against the test bench testing rules that are used for the regulatory rules.

In yet another embodiment, testing business rules against this test bench may identify business rules which may not be in compliance with the company's own or broader industry standards such that the business rules may be modified, removed or otherwise amended. However, it will be appreciated that business rules are preferably independent of regulatory and/or industry rules.

In yet a further embodiment, an approved product list may be provided to the system. The approved product list can preferably be customized by a licensee, such that the approved product list can better correspond to company or business preferences. The product list may be an inclusion and/or exclusion list such that sub-licensees or other predetermined users of the system which rely on the licensee are restricted or guided to only the products or services that the licensee dictates. In one example, the licensee is a regulatory body, which may be associated with a government department. Products such as venture capitalist trusts, spread betting, contracts for difference, land banking, and unregulated investment schemes may be classified with a risk which is too high, and therefore may be products which a sub-licensee may not be able to see on an approved product list. Other products may relate to non-regulated products or services, which the licensee may or may not wish to allow sub-licensees to provide advice or services for. A licensee may dictate that only authorized representatives or users of the system with specific training and/or an experience threshold in a relevant field can provide advice on. For example, a real estate agent may have the skills and education to competently advise on real estate/property, while an accountant may not.

The approved list may also require prewritten wording of sections of text. For example, standard disclaimers or terms and conditions may be a part of a document to reduce the potential for ambiguity with documents. This may also assist with reducing legal risk regarding whether a clause, disclaimer, or other predetermined text was included with a document. This can further assist with unifying documents and may assist with making documents more searchable on the system and easier for expert users to identify related documents based on disclaimers or clauses within the document. In addition, branding or marketing items may be part of the approved list which may assist with increasing sales. For example, a home loan lender may also have clauses for other services related to purchasing a home, such as conveyancing services, which may assist with generating additional revenue. The licensee may also associate different sub-licensee companies or businesses such that if a client wishes to take additional services which a first company does not offer, but is suggested or offered in a document, the first company may have access to a second company which offers those services. The second company may have an agreement or arrangement to provide compensation or a finder fee for the referral. This may also assist with marketing for sub-licensee companies or businesses.

Other items may also be added to the list for prohibition, such as explicit language, politically incorrect phrases or sensitive issues. The prohibition list may be generated or tailored for a particular client. For example, an entity or company with a particular target market may have additional terms or items added to a prohibition list such that there is a reduced risk of inadvertent offence being made to a client.

In yet another embodiment, the system is adapted to access one or more external data sources. The external data sources may be a website, a video sharing source, a file hosting source, an audio source or any other predetermined source of information. More preferably, the external data source may provide details regarding regulatory bodies or legislation relevant to a sub-licensee. The system may be able to obtain skills, credentials and qualifications of a user, for example, license numbers or specific regulatory authorizations. This may be of particular use for taxation agents as they typically require external data sources for regular business activities, for example asset data of a client may be required from a number of sources. Further, the authorizations and/or licenses may be permanently stored by the system or temporarily stored. If the authorizations or personal information of a user is stored, the private information will generally be of a confidential nature and be encrypted or otherwise kept in a secure location such that unauthorized persons accessing the system cannot access confidential information which is not associated with their profile.

Based on the authorizations and/or qualifications of the user, the system may apply or remove filters for a user. The filters may correspond to the rules which are triggered by a user, for example a user who is a certified taxation agent may not trigger rules relating to the provision of taxation advice. It will be appreciated that administrators or moderators of the system can manually update rules, filters and/or exceptions applied to a user.

Mapping (or creating a web) business rules, and product lists may be made by groups, participants or other users of the system. Mapping can optionally act as a filter, such that a user not associated with a predetermined map or web may be subject to different rules than those associated with the map or web. Putting users of the system into groups may allow for more than one user to be assigned customized or specific rule sets relative to other users of the system. If a rule or exception to a rule, for a particular user, is based on a registration, authorization or qualification, the system may check to determine whether the registration, authorization or qualification currently exists such that the rule or exception to the rule is applied correctly. It will be appreciated that a check may be done in real time when a rule is to be triggered, or the system may periodically or randomly check to determine whether the registration, authorization or qualification still exists for a user. If the registration, authorization or qualification no longer exists, the rule or exception to the rule may be revoked by the system until reinstatement of the registration, authorization or qualification is restored. It will be appreciated that expiration dates associated with the registration, authorization or qualification may also be monitored by the system to ensure that renewal fees or renewal requirements are met before expiry of the registration, authorization or qualification. In yet a further embodiment, the system may also allow for tracking of Continuing Professional Education (CPE) points or other industry required learning.

Manual modification or amendment to the automated authorization may be made by an authorized user of the system. Modifying automated authorization can assist with the development of business rules which are specific to a business or company.

In yet another embodiment, the system is adapted to link various accounts of a user with the system. For example, the system is adapted to link or associate social media profiles, websites, usernames, accounts or other digital assets with a user profile. The system may then review the linked or associated digital assets of the user to generate a compliance report. Reviewing digital assets may further reduce the risk for a company or business, as the company may also be able to generate a personality profile to better understand users. If there are any non-compliant articles, comments, or social media posts associated with a user, the user may be able to see which posts or comments are not compliant and review, edit and/or delete non-compliant data.

The system may further build associations or links made after the initially linking a social media profile. For example, a Facebook™ profile may further be associated with another online account made by a user upon signup for an online account. If the user uses Facebook™ to sign up to the online account, the system may also be notified and the new online account can be added to the user profile data. The new user online account may then be scanned or scheduled to be scanned by the system to determine whether there is non-compliant data. Optionally, the system can check or monitor the creation of digital content in a digital asset, such as a social media account. The user may be required to receive authorization from a user with sufficient access before being able to post a comment or generate digital content. Alternatively, the system may provide suggestions before digital content or a post is generated such that the user can be aware if a post may potentially breach compliance. Providing suggestions to a user before posting a comment may allow additional safety as users may rethink negative comments or rethink wording of comments or digital content before publication. It will be appreciated that a robo-advice platform may be used by the system to guide users.

Optionally, the system is adapted to extract at least one data set from at least one user profile. The at least one data set may be assessed in relation to other profile data sets extracted and compared to ensure consistency. This is particularly useful for data relating to the work history of the user such that no misleading or inaccurate information is accidentally uploaded to the system. If the system detects conflicting information between the profiles, the user may be notified such that they can remedy the conflicting data sets if appropriate. Extracting data from at least one user profile may allow the system to generate a profile automatically for a user, or streamline the generating of a profile without the user being required to upload data manually. This may incentivize a user to sign up to the system as this may reduce the time taken for generating a user account.

It will be appreciated that a scan of a webpage may include and/or exclude advertisement material which is associated with the page. Gifs, animations, videos, metadata, adwords, tags, images or the like are may also be assessed by the system for compliance. If there is advertisement material which may be potentially non-compliant the system any flag the advertisement for review or send a request to the advertiser to remove or modify the advertisement to bring it into compliance to reduce the risk for potentially misleading or deceptive advertising.

It will be appreciated that scanning of digital assets or online content may be periodically performed, or performed more frequently with respect to rapidly changing websites or online content, such as a social media page. Optionally, some websites or social media platforms can be continually monitored, such that non-compliant documents, posts or the like can be flagged and/or removed more quickly. Websites which are historically inactive for large periods of time may be scanned less frequently relative to more active websites or digital content.

Content generated by a user in any digital form which is not attached to digital objects, such as marketing brochures, statements of advice, emails, etc. may be input directly into the system by a participant, or via an API to an external system.

Typically the system allows a user of the system access to at least one of; create new content via the system, analyse the compliance status of newly created or unpublished content, analyse the compliance status of published content, view the compliance status of content published to their digital objects, view the compliance status of unlinked digital content, manage the process of tracking and remediating non-compliant content.

Content input into the system is analyzed for noncompliance with respect to at least one compliance rule based on applicable regulatory and legislative rules applicable to different license authorizations & business rules, which may also be referred to as a rule base.

A compliance report can be generated for at least one content item which has been detected as being compliant or non-compliant. The compliance report may include the applicable rule or rules which have been breached, the risk rating of the breached rule and feedback. The feedback may provide guidance to a user such that the feedback may provide suitable suggestions as to how to reduce the risk or how to avoid triggering at least one rule. For example, the system may be adapted to provide a list of qualifications which may avoid triggering a rule, such that the system can encourage further learning.

Actions performed by users of the system may be used to provide feedback. The users may be able to use the data generated by the system to assess and reduce potential risk. Data regarding non-compliance may be able to identify authors with less experience or authors (users) or compliance managers (also referred to as users) which require further training based on the content of a document to be reviewed by the system. For example, if a user has a historical record of generating documents with a number of high risk comments or text above a predetermined threshold may be flagged by the system as requiring more training, or may be flagged by the system to receive further education service options, such as recommending tertiary training courses or the like. Further, the system may be adapted to be integrated or used as a plug-in or extension for document generation software, such as Microsoft Office™, OpenOffice™ Google Docs™, Adobe™ software or the like.

If the system is adapted to be used as a plug-in, extension or is integrated into document generation software, the system may monitor the time in which a user spends working in a document, the number of times the document is saved, and the number of documents generated, and log the document data. Based on the logged data, the system may determine whether a user is generating enough compliance reports to reduce potential risk, and if the system determines that the number of compliance reports is not sufficient, the user can be flagged for management to review whether the user has been generating enough compliance reports based on the log data.

Further, the actions of the users can be used by the system to improve the utility, and can determine whether there is significant non-compliance regarding a particular rule which has been triggered. The actions of users may also assist the generation of new rules, or may review sentence structure generated by users which may provide a lower risk or a clearer sentence structure for reducing ambiguity or other risk factors. In addition, the actions taken by users may prompt a review of at least one rule based on content generated, user comments input when a rule is triggered or whether a threshold of users disagree with a rule.

As mentioned above, as some users of the system may require additional training, the system may provide a company, business or user with information regarding additional training services. Optionally, tertiary education services or other education or training service options may be provided via the system. The further training or educational service options may relate to jurisdictional or local services, for example a user living in New York will only be provided with options within a predetermined distance from their current postcode. It will be appreciated that the system may provide sponsored educational services which are not restricted by a distance from the user. As such, the system may allow for the establishment of a market-place for legal and/or regulatory guidance and training services which may be provided to users of the system.

Regulatory and legal guidance aids may be pre-seeded or associated with the system, such as links (e.g. web-links or embedded hyperlinks) or documents (e.g. training manuals, training materials, infringement notices, regulatory guides, information sheets or any other guidance material). Optionally, further documents, training manuals or links can be associated with the system which may be developed at a later time, or which may not be strictly relevant to a profession, however, may be desirable for “best practice” or to comply with company policies.

Preferably, the training content may be delivered to a user at the time of content authoring. This is to say that the system may issue real time training content to a user dependent on the content authored in a document, or the user may search for desired training or guidance material. The training or guidance material may be displayed to a user when amending or reviewing compliance issues of a document, or at predetermined periodicities. Training materials may be delivered to a user via text, a graphical representation, a video, a diagram, audio and may highlight or otherwise make obvious non-compliant content of a document. It will be appreciated that the training content may be free, or may require payment before access, for example if the system is adapted to access a journal article database the system may require a subscription before materials are accessible.

A company or business may act as a node of the system, in which users of the node only influence the system leaning of their respective node, and the users do not teach the system for another node (i.e. another company or business). Restricting learning to a node may prevent competing companies taking text or other publications from one node without consent. In addition, having only users of a node influence other users of a node will assist with generation with more standardized or consistently worded publications, which may generate a positive reputation for a company. In one example, if a user wishes to generate a known type of document, the system may provide suggestions with respect to pre-generated text to be inserted which is known to have a known risk associated therewith. Alternatively, the system may allow a drag and drop function to insert desired text based on previous text seen on a respective node. The system may also prompt users with information or text used by similar users to that of the current user; this may help with training or development of skills of the current user.

The system may provide workflow tools including permissions as author, content workflow to approve content, content workflow to remediate content (such as published on websites via a ‘site owner’ user, retraction of social posts, tools to deliver corrected messages via email and the like), real-time capture of all published content (such as, exact format, date stamp, place of publication, proof of compliance check process), or audit capability. Other workflow tools may also be used by the system to increase potential productivity of a user.

With regards to regulatory rules, the system may be required to be in compliance with at least one item of legislation. The legislation may be generated by a state, territory, sovereign nation, a federal governance body, or any other jurisdictional legislation provider.

In one example, the system is adapted to comply with Australian financial legislation and rely on at least one of the following; Corporations Act 2001 (Cth), ASIC Act 2001 (Cth), National Consumer Credit Protection Act 2009 (Cth), the Australian Consumer Law. It will be appreciated that the system can be adapted for any jurisdiction with respect to local and/or international laws.

The system may also provide the user with potential penalties for breaching legislation, such that a user of the system may see the potential ramifications for using noncompliant text in a publication. Other regulatory guidance in relation to regulations and legislation may also be accessible via the system. For example, non-compliant text which has been detected by the system may provide the user a link to relevant legislation or articles which may be relevant to the breach, such that a user can better understand why the text is potentially non-compliant. If the user does not consider that the text is in breach of identified legislation, rules or regulations, the user may flag this with the system for a review.

A flag for review may generate a report for a user of a higher level, if the user who detected the potential error does not have a level, to assess whether the review has detected a logic flaw of the system or a rule which does not comply with legislation or a rule. If the rule does not comply, the user assessing the flagged review may override a rule, request that the system reassess the rule, amend the rule, or the rule may be suspended until a moderator assesses whether the rule should be amended, removed or otherwise altered.

A flag for review may have a comment input by the user which may identify why the user believes that a rule has incorrectly been triggered, or if the rule is insufficient or whether the user wishes to provide a comment in relation to a rule. A comment input by a user may be assessed by a moderator, expert committee or other user with sufficient level, such that the comment can be used to provide additional guidance with relation to a rule. For example, a user may believe that the rule is being triggered based on an incorrect keyword or due to a syntax error, and therefore may not be triggered for the correct reasons. The rule may then have additional parameters assigned thereto to refine the triggering conditions such that there are fewer instances of detected non-compliant text. A user may optionally agree with a triggered rule and may offer additional suggestions where the rule may also be triggered and may input text to assist with self-learning and potential training.

In yet another embodiment, the system may provide a compliance report which the user can review identified non-compliant text. The user will then have an option to assess any triggered rules and how the triggered rules impact on the document. The system may be adapted to allow a user to optionally link rules with sections of text in the document. Linking text may force the system to assess whether a triggered rule has been correctly triggered. For example, a rule has been triggered in view of non-compliant text, but has not identified text in another part of the document which brings the identified non-compliant text into compliance, such as a disclaimer or alternative recommendation or opinion. The disclaimer may nullify the identified risk associated with a triggered rule, or an alternative recommendation or opinion may allow the document to be less biased and therefore reduce the risk that the document has produced a skewed or biased opinion.

The compliance report may further have features which allow a user to confirm or reject a triggered rule. The features may be icons relating to the action desired by the user such as a tick for agreeance, or a cross for rejection. The user may optionally input a comment or upload a justification document in response to a triggered rule. A justification document may allow a rule to be reassessed by the system, for example, if a piece of text which triggered the rule is based on the justification document, the system may deem that piece of text is compliant based on the justification document. For example, a document may be generated in response to an article or proposed legislation, such that the text of the document may allowably be more biased and opinionated relative to other documents intended for publication.

Optionally, a user of the system may input a document type to be generated into the system, such that different rules may be triggered for different types of documents. This is to say that the type of document may directly relate to the threshold values of a rule. In one example, the threshold values of a document may be more strict, or have a lower threshold, for a document which may bring more potential risk. A document with more risk, such as a published journal article or a letter of recommendation, may require more succinct wording of the document to avoid potential miscommunication and provide a greater potential for a client or reader to understand the content of the document. This may ensure that ambiguity for a document is minimized and provide a lower risk document. However, if a document is an opinionated piece for an industry specific journal, for example, the document may have a higher threshold to trigger a rule as industry professionals are more likely to understand industry jargon, legislation, and have a better understanding of the comments presented in the document relative to non-industry readers.

Expert users may view compliance reports which are assigned markers such as; correct, incorrect and/or incomplete. The expert user can determine whether the markers are correct or modify them. If an item of text is correctly identified as compliant, a lower risk value will be applied thereto and the expert user may not update or modify a rule associated therewith, while an incorrect or noncompliant item of text which has been identified as compliant may actually be in breach of an existing or to be newly created rule and therefore be labelled as incorrect by the expert user who can assign at least one existing or proposed rule thereto, or an item of text may be incomplete, for example a sentence may finish without being completed or there may be missing justification or reasoning for an item of text. Incomplete text may be assigned one or more rules, assigned a rule by the user or assigned a new rule which did not exist by the expert user. The system may also be able to determine that detection of non-compliant text is incomplete and further input may be required to adequately determine compliance. Preferably, the expert user can tag the compliance analysis with other free-form comments useful to rules development.

Optionally, for each content item, expert users can override the system's generic feedback and provide tailored or more detailed feedback, such as amended text or legal analysis, to be delivered to the participant in respect of that content item. Each content item tagged as having compliance analysis which is either incorrect or incomplete and each new rule proposed may be automatically analyzed by the system to assess the need to change the rules base (or may be manually assessed by a user of the system). Content items reviewed by expert users are checked by the system for anomalies and may be added to the test harness against which modifications to the rules base are assessed. Expert users may issue reports to participants to supplement the system's compliance analysis with their compliance analysis and feedback. Preferably, the actions of the expert users on each content item is captured by the system and used to generate and test automated rules modifications, and possibly to enhance feedback provided by the system.

The system preferably applies automated decision making logic to the actions of multiple users, which may identify anomalies in assessments, or may generate a proposal for a new rule or modification to an existing rule for testing against a test harness. If the new or modified rule passes testing the new or modified rule may be implemented by the system, or if the new or modified rule does not pass, the new or modified rule will not be implemented and review of the proposed new or modified rule will be required. However, the system may propose further changes to the rule and retest these modifications to determine whether the newly modified rule can pass. The system may apply logic to determine how the new rule is to be enacted in the system. Once a new rule is implemented, the system may update at least one of expert users and/or users. Updating users of new rules may be done periodically, such that notifications of rule changes are easily found in a single location.

If pre-defined testing thresholds are not met, the proposed rule modification/new rule is either held under development as the system collates more test data (content to develop the consensus position or content to supplement the test harness) or reported via the system to the expert committee for manual moderation/guidance.

The expert committee may provide manual moderation of the system rules and the development of the rules. The expert committee may also review machine generated rule modifications as described above with data from analysis of the consensus position developed by the system or data from the analysis of various implementations against the test harness.

In yet another embodiment, the system can identify where expert guidance is needed for best practice or a particular area of the rules or a particular rule and deliver this guidance to participants via the system using a broadcast model (which uses all users and/or all expert users), or a targeted communications model (only users with pre-defined authorizations, with relevant areas of interest, previous violations in this area, for example, a rule about insurance may only be delivered to participants who are authorized to provide insurance services), or a targeted real-time training model (only to content authors/compliance managers when the particular rule/s applicable to the guidance is violated and for a specified number of subsequent violations (for example, a clarification to a rule about SMSFs may be delivered to authors/compliance managers when a rule relevant to SMSFs is breached for the first time after the clarification is issued, and then for the next two instances of a breach of this rule).

Develop a training and test data set of compliant and non-compliant content (for example, ‘X’ compliant/good quality statements of advice, ‘Y’ non-compliant/poor quality statements of advice). Training data may be tagged to determine relevant content for the NLP/models to analyse (for example, in statements of advice, train the system to identify fact summaries, advice/recommendations, disclaimers or the like). This can be done independent of the system (manually), or utilizing the current decision logic of the system for subsequent manual verification.

Identify the non-compliant aspects of the training data set (such as poor advice or product bias in the statements of advice). This can be done through review by expert users using in the system, or manually. The process may involve the steps of; tagging the test data set as compliant or non-compliant, identifying the specific text which is tagged as non-compliant, analyzing the tagged non-compliant text to determine relevant rules, test the proposed rules with at least a portion of the tagged training data set, analyzing results, refining and re-testing in the manner described herein for a required number of times until the process may be able to classify the compliance status of a pre-defined number of training data sets. The pre-defined number of training data sets may have a pre-defined rate of precision and recall. The process may be performed independent of the system (manually), and/or may be performed utilizing the system decision logic & existing rules for subsequent manual verification, and/or may be performed utilizing the system's NLP/machine models to determine patterns within the non-compliant data that can be the basis of a new rule (i.e., when facts 2, 3 and 4 are present, recommendation 1 is non-compliant; when facts 2, 3, 4 and 5 are present, recommendation 1 is compliant).

A version may be developed based on the new rules through system rules explorer (an interface into existing rules and their decision logic). The system can then test the robustness of the first version rules against the test data set, iterate/modify until a required level of precision and recall is achieved and implement the rules if the rules pass testing. The system may be adapted to continually test and refine the rules in the field e.g. participants provide statements of advice to checked by the system (e.g., emailed, as an API from a robo-advice platform, manual upload, or through the continual monitoring of content published on websites).

The system could be implemented for any person, business or industry that has external or business rules that need to be complied with in relation to published information. For example, parties who need to comply with false and misleading advertising legislative for product labeling and other marketing communications, other highly regulated industries with external rules (such as pharmaceutical sector), employers with respect to communications with employees or contract review—presence of certain offending clauses, absence of certain protective clauses.

An expert committee may be used to improve the recommendations provided by the system. The expert user committee may optionally allow multiple recommendations to be appropriate for a single topic, however a best practice recommendation may be offered to a user regardless of whether a current item of text is compliant or non-compliant.

The system may be adapted to reuse actions of expert users. There is a greater exposure to expert users and their comments and recommendations. Allowing expert users to input data into the system may allow relatively less experienced users the benefit of seeing expert user comments and recommendations which may assist with education and training. The system may be adapted to identify non-compliance based on expert user input or training. The experts can retrain systems if they believe that the system has generated rules or other data sets which may not yield the most accurate or appropriate wording for items of text, and the expert users may also make allowable items of text. The system can be used to assess pre and post production documents or data.

The system can be updated in real time. A compliance report is preferably sent to a manager of the author of a document after a compliance report has been generated. Issuing compliance reports to relatively more senior users of a company may provide additional risk management as the relatively more senior users, such as managers, can review and/or amend a proposed publication before being published.

As discussed above, a document may be uploaded to the system for a generating a compliance report. However, the system may also be adapted to perform periodic or random checks of material which has already been published.

The system may be adapted to retrospectively assess documents based on updated rules. Legislation or regulatory change is an inevitable fact for most industries, and determining compliance for published documents is essential if the documents are being used as current publications for a business or company.

Further, the system may be adapted to assess the publication date of a document such that regulation or legislation changes after the publication date do not impact the assessment of the document. For example, a document published in 1990 may be accurate and have a low risk when compared with legislation current during the year 1990, however a legislation change during the year 2000 may increase the risk of the document to a high risk document. As such, the system may be adapted to apply different rule sets which relate to the publication date of the document such that documents within a desirable risk relative to the legislation at that point in time are not flagged as a higher risk by the system in view of current legislation which may increase or reduce the risk level of a document.

In yet a further embodiment, the system may have at least one temporal rule which detects potentially out-of-date items of text in a document or publication. For example, an item of text relating to a tax regime which has been repealed may be present in a document which is therefore out-of-date or non-compliant. The temporal rule may then trigger in a review of document and a notification or flag may be applied to allow for change of the item of text. Optionally, the system may be adapted to store triggered rules of a document, such that when rules change, any documents with a triggered rule associated with the changed rule can be reassessed for compliance.

Further, items of text which could be construed as a “material statement” may also be detected by the system. A material statement may relate to a physical outcome from the statement, such as a return on investment calculation. The physical outcome of a material statement is generally important as these statements are generally sources of misleading information and therefore should be as easy to read as possible.

A document may also be assessed in view of passed legislation which is not enacted, such that future compliance for a document can be assessed. It will be appreciated that if non-enacted legislation will reduce the risk factor of a document, the system will preferably generate a compliance assessment based on the higher risk such that the document will be in compliance both before and after enactment of legislation. It will be appreciated that more than one document may be generated for compliance under different legislations. For example, a first document may be generated for existing legislation compliance and a second document may be generated for legislation once enacted. If multiple documents are generated, the system may be adapted to replace a first document with the second document once legislation is enacted to ensure that the document is continually in compliance. A link may optionally be provided for the first document after it is replaced such that the first document may retrospectively be viewed.

At least one dataset may be assigned to a document after the system has checked a document. The at least one data set may be a time of the performed check, the current legislation at the time of the check, a publication date of the document, a review date of the document, an author of the document and a level of the author.

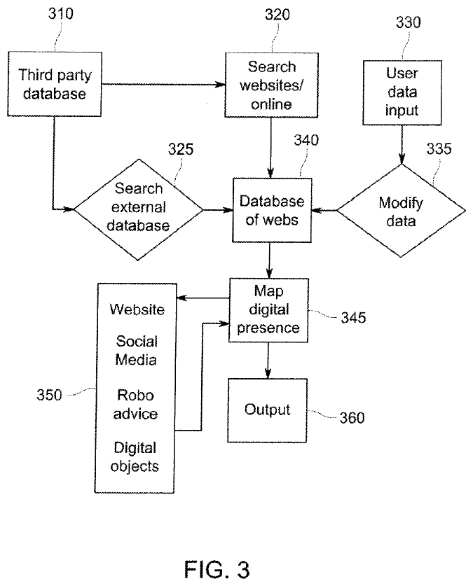

Referring to FIG. 3 there is shown a flowchart of an embodiment of digital mapping for a user. The digital mapping can link at least one data set with the system, such as that of a social media profile or personal website. User details may be stored on a third party database, such as a company or business server or a personal computer 310. At least one data set associated with a user can be extracted by the system 10 and used as the basis for a search on the internet, or an intranet. Optionally, external data sources may also be searched which are not on the internet. The uncovered data can be stored in a database of users, either temporarily or permanently 340. Alternatively, user data may be manually input into the system 330 by a user (either the same user or an authorized user), and then the mapping portion of the system may optionally modify the data 335 or override external data for the user with the new data. Inputting data may be required if there are errors with existing data sets for example, however the input data may then also be uploaded to the system user database 340.

The user data stored in the user database 340 can then be used to map the digital presence of the user 345 by searching the internet or other platforms for the digital presence of the user 350. For example, the search may include websites, social media accounts/profiles, third party services (for example, robo-accounts) or any other digital objects or digital content. The results may then be linked with a user and/or stored in the user database. An output, such as a compliance report, may be generated for a user based on the uncovered data 360. The compliance report may report to the user if there are any uncovered noncompliance issues which are to be preferably remedied. Optionally, the system may search and remove non-compliant data on behalf of a user.

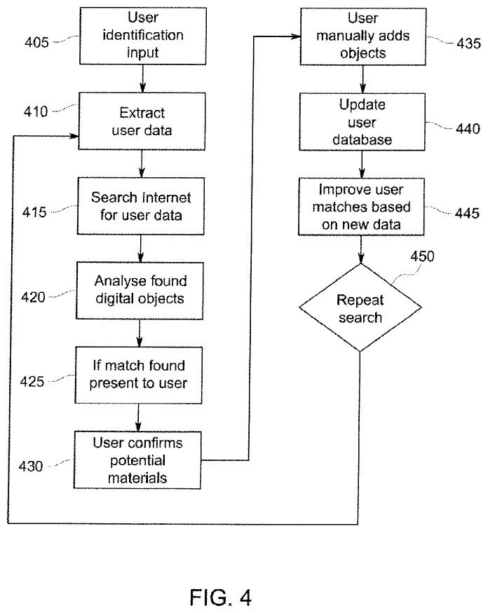

An example of an embodiment of a digital mapping process is illustrated in FIG. 4. The digital mapping process in which user data is input into the mapping system 405. The user data may correspond to a specific identification of a user, such as in industry registration number. The input user data is then used to extract user data from an associated database 410. A search of another database and/or the internet may then be conducted 415 and any objects found which may be relevant to the user may be analyzed by the system 420. The user may have the option to veto or remove at least one piece of found data 425 if the user wishes it to be excluded or the user believes that it is not relevant to the search. The user can then confirm potential matches uncovered by the search 430 and can add any additional data manually which may not have been found or considered relevant 435. The user database may then be updated with the new data 440. Based on the new data stored, the system may alter or otherwise improve searching functions 445 for at least one user. For example, a new social media platform may not have been previously searched by the system, but manual addition may cause the system to subsequently perform a search for at least one other user. In another example, a username or profile name associated with at least one user may then be linked to that user, such that multiple instances on the internet of that name may cause a link to the user to be found. The search may be repeated at predetermined periods 450 and may start back at step 410.

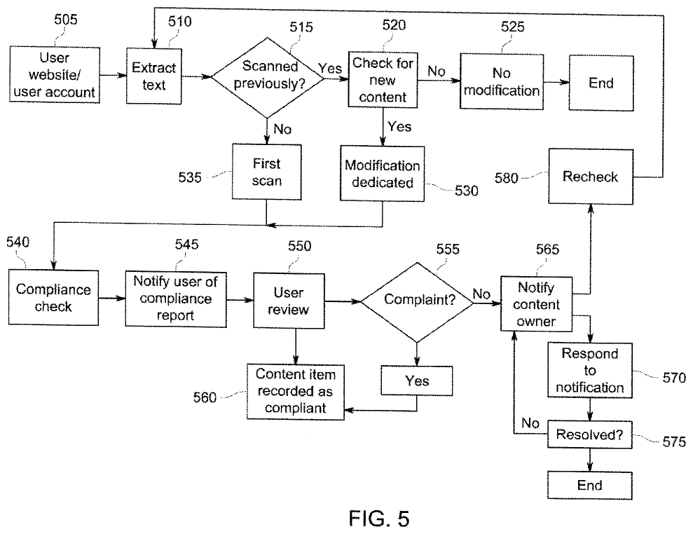

FIG. 5 illustrates an exemplary embodiment of the workflow of external content. A user website or a user account (such as a social media account) is scanned 505 by the system 10. The text content from the webpage or account is analyzed 510 and a determination is made with respect to whether the page has been scanned before. If the page has been previously scanned, a check for new content is made 520. If new content is not found 525, the system ceases analysis as a compliance check has already been performed. However, if there is new content found or modification detected 530 a compliance check is performed 540. A compliance check will also be performed if this is the first instance of scanning the webpage or account or if new or modified rules have been implemented in the system since the date of the earlier review 535. A user of the system, such as a manager or predetermined other authorized user, can be notified of the compliance report 545 generated at 540 and then review the compliance report 550. A check for compliance is made 555, and if the report is compliant no further action may be necessary 560. If there are compliance issues the predetermined authorized user can notify the content owner 565, or in one embodiment remove the non-compliant text on behalf of the owner. If not already removed, the site owner can review the flagged content and respond to the compliance issue by removing the issue 570, or returning justification as to why the content is allowable. The manager may then remove the flag from the website content if the situation is resolved 575. The webpage can then be scanned again at later instances, manually, randomly or periodically 580. Optionally, each content compliance report is stored by the system to retain a log of events.

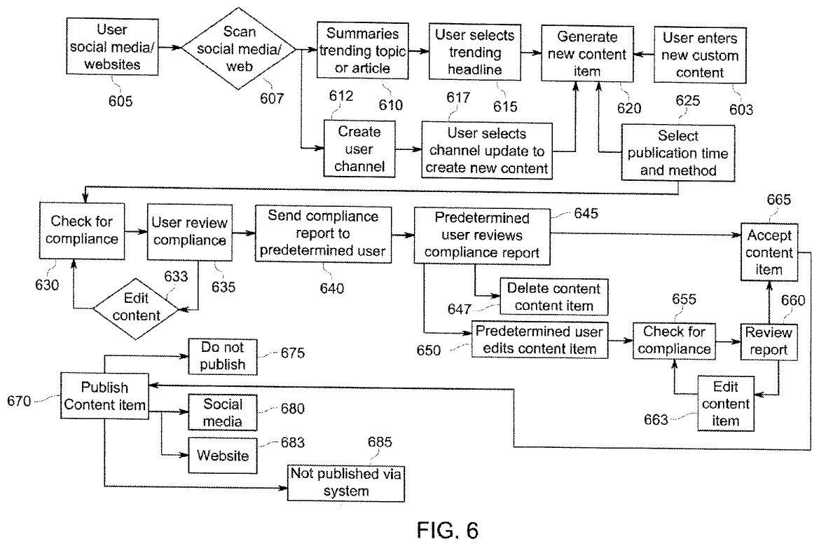

Turning to FIG. 6, there is illustrated an embodiment of the workflow for content. The user can nominate at least one social media account, website or other digital content 605 for the user to develop new content ideas. The system may then summarize at least one item of digital content or create a user channel 607. Summarizing a topic may rely on Rich Site Summary (RSS, also known as Really Simple Syndication) data or other metadata, which may be headlines of articles or trending topics. The user can then quickly assess whether any articles or content are relevant or desirable for publication as a new content item publication. If the user selects at least one content item to generate a publication, the system may generate a provisional publication 620. Alternatively, the user may generate a channel 612 based on metadata or RSS feed. Multiple channels may be associated with a user across a multitude of industries, or a single industry with type specific feeds. For example, a lawyer may have a channel for law related materials and specific feeds for conveyancing, international law, contracts, or any other desired feed. The user may view each feed separately or as a single feed, and may optionally select at least one item of the feed for publication 617 by generating a provisional publication 620. Alternatively, the user may manually enter a custom provisional publication which is not associated with a feed 603.

The provisional publication may be associated with a publication time and/or a publication method 625. The method may be associated with the platforms or websites in which the content is to be published after passing a compliance check. The system then checks the provisional publication for compliance 630 and generates a compliance report. The compliance report may then be reviewed by a user 635 and the user may optionally edit the content 633 and conduct a further compliance check 630. If the user is satisfied with the provisional publication, the compliance report and provisional publication can be sent to a predetermined user 640 to review the compliance report 645. The predetermined user can be a manager, an expert, a secondary reviewer, the same user or any other predetermined user. It will be appreciated that if the predetermined user is the same user, steps 635 and 640 are missed and step 630 leads into step 645.

The predetermined user may then have the option to delete the provisional publication 647 if desired. Alternatively, is there are no compliance issues, the provisional publication can be optionally published 665. In one embodiment, the provisional publication may also be published even if there are non-compliance issues. It will be appreciated that the term “provisional publication” may refer to any type of desired document or publication. If there are instances of non-compliance in the provisional publication, the content of the provisional publication may be edited 650 to be in compliance if desired. The system may then perform an additional compliance check 655 and the predetermined user can review the provisional publication 660, and again edit the provisional publication 663 if desired or if there are further non-compliance issues. The user can then accept the provisional publication 665 preferably only if there are no compliance issues.

The accepted provisional publication may then be optionally published as a content item 670. Optionally, the provisional publication may be delayed publishing for a predetermined period of time, or indefinitely 675. The content item can be published on any desirable digital medium, such as a social media account or a website 680, 683. The user may also or alternatively publish the content item without the aid of the system 685.

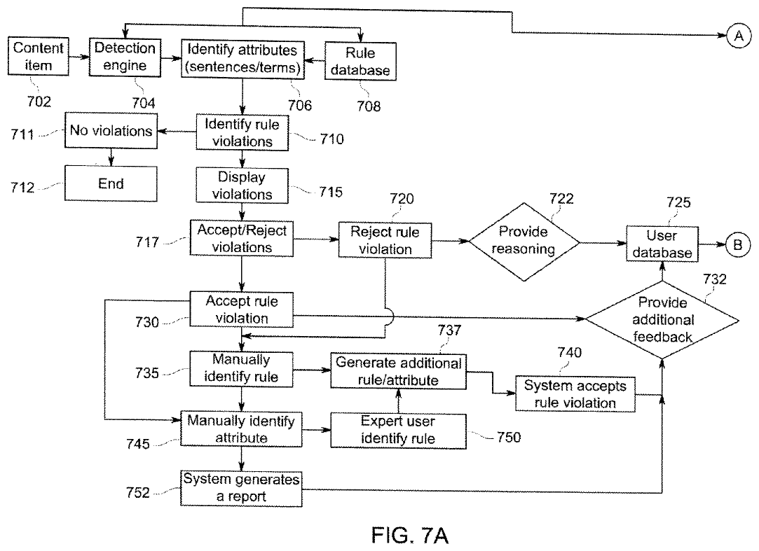

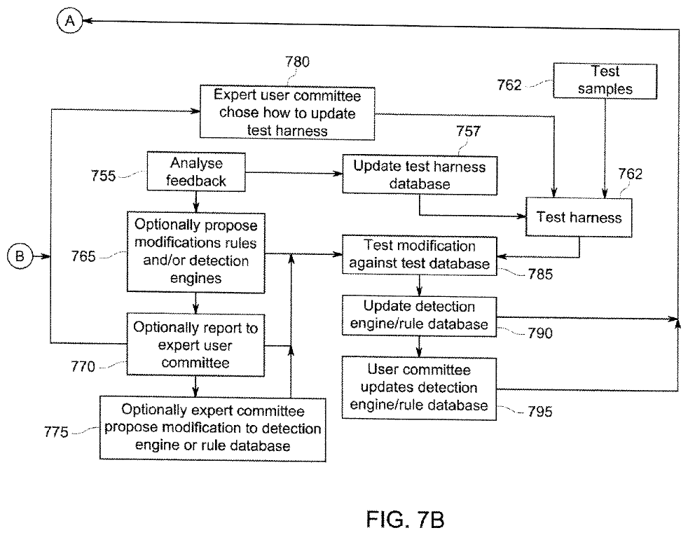

FIGS. 7A and 7B illustrate an embodiment of the system of the present disclosure. A content item 702 can be uploaded to the detection engine 704 for analysis. At least one attribute may be identified by the system, such as a sentence, a term or any other text item 706. At least one rule may be used in the analysis 708 which may detect noncompliant text or attributes of the content item 702. The analysis will determine whether any rules have been violated 710. If no violations have occurred 711, the compliance check may be ended 712.

If there is at least one compliance issue, the violations can be displayed to a user 715. The user may then accept or reject the violations 717. If the user rejects the violations 720, the user may optionally provide reasoning for the rejection of the violation 722 before the data is uploaded to a database 725, such as a user database. If the user accepts the violation 730, the user may optionally provide additional feedback 732. If the violation is rejected 720 or accepted 730 the user may optionally identify another rule which is violated 735. Based on the violation, an additional rule or attribute may be generated 737 by either the user or the system, and the system can accept the new attribute or rule 740 to then be uploaded to the database 725 for testing. Optionally, the user may provide additional feedback for the system to assess 732. The user may also optionally manually identify at least one attribute 745 of an accepted rule 730 or a manually identified rule 735 which the user can identify an associated rule for 750. A compliance report can be generated 752 based on the system check of the content item 702.

The data uploaded to the user database 725 may then analyse the feedback and/or input of the user 755. The feedback and/or input from the user can be used to update the test harness 757 and the test harness database 760 may receive the updated test harness data 757. Optionally, additional test samples 762 may be uploaded to the test harness 760. Based on user interactions at at least one of 720, 730, 735, 745 or the feedback 722 and 732, modification of rules and/or the detection engine can be made by the user or the system 765. The user interactions and feedback may also be provided to an expert committee for review 770 and modification of rules and/or the detection engine can be made by the expert committee 775. The test harness can be manually updated by the expert committee 780 which can then be provided to the test harness 760.

The test harness can test any modifications to rules and/or the detection engine against the test database 785. The detection engine and/or the rule database may be updated by the rules and/or detection engine 790 based on the results of the test against the test database and/or the test harness. Alternatively, or in addition, the expert committee may update the detection engine or rule database 795. The updates may then be forwarded to the detection engine 704/rule database 708.

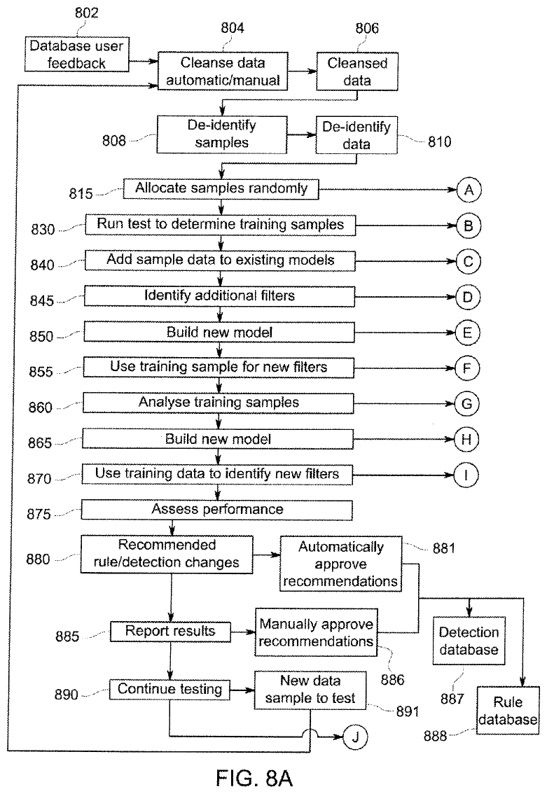

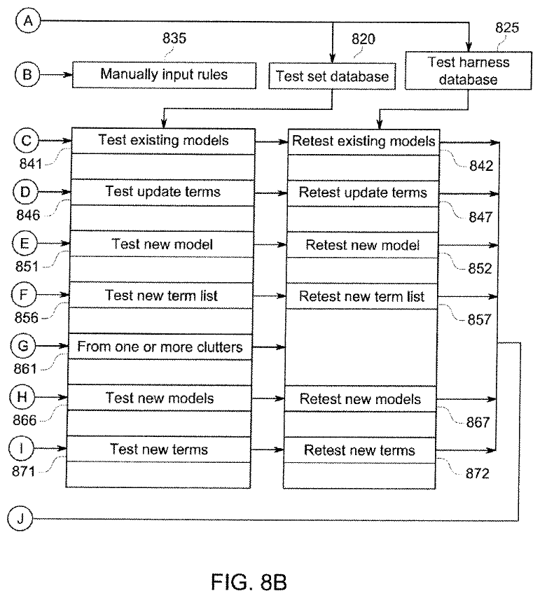

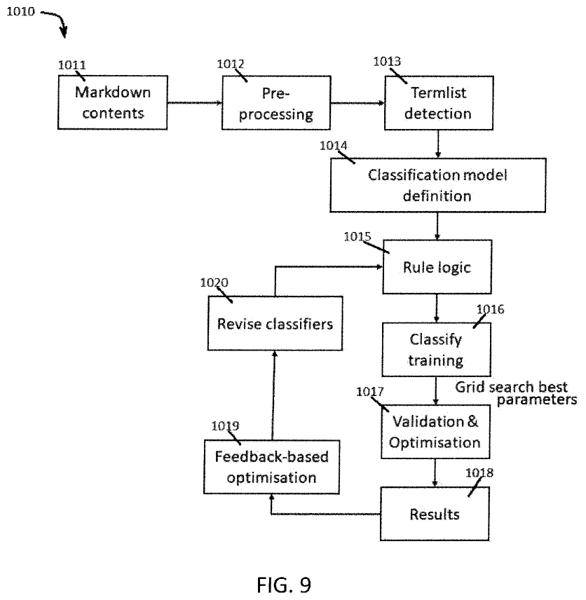

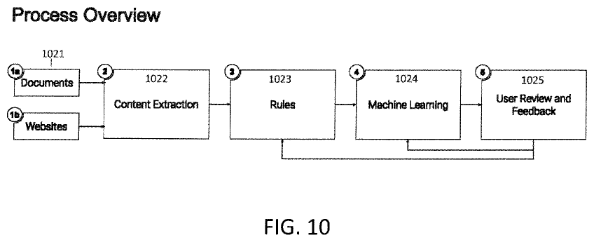

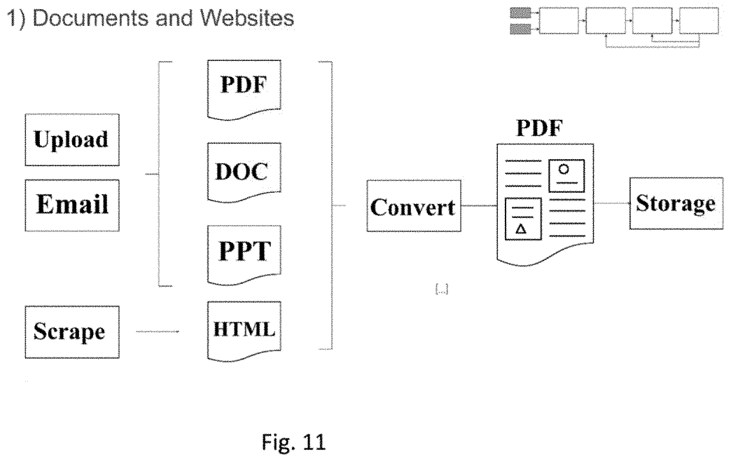

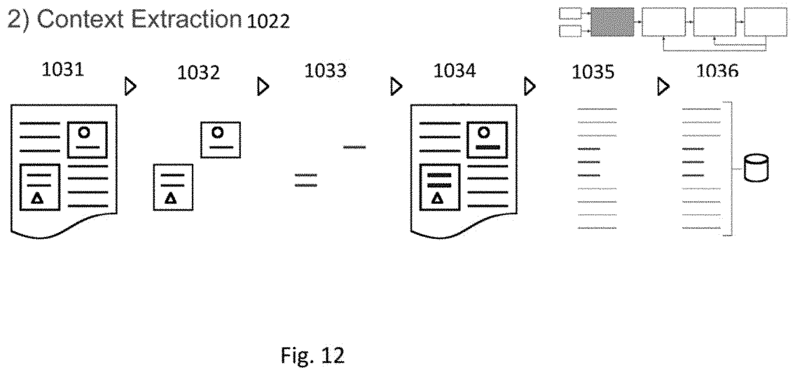

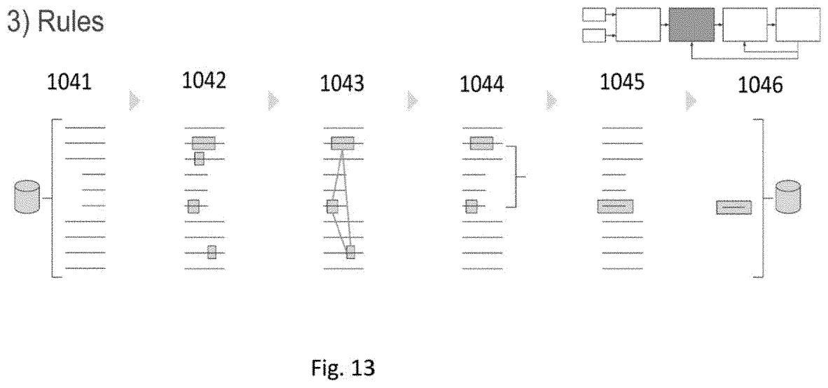

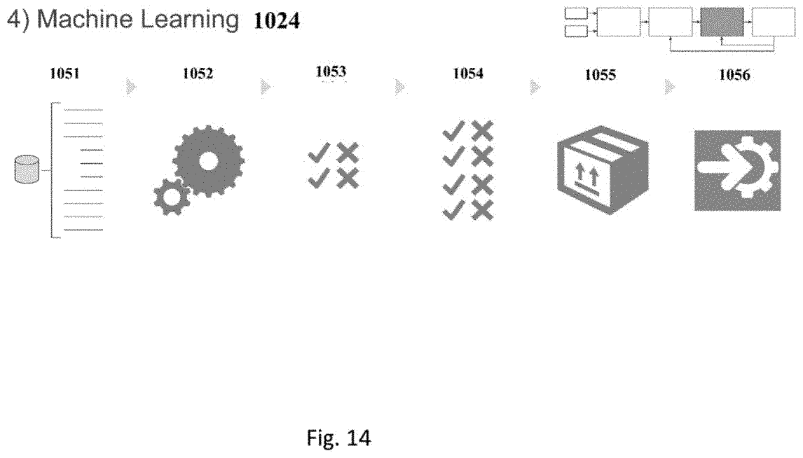

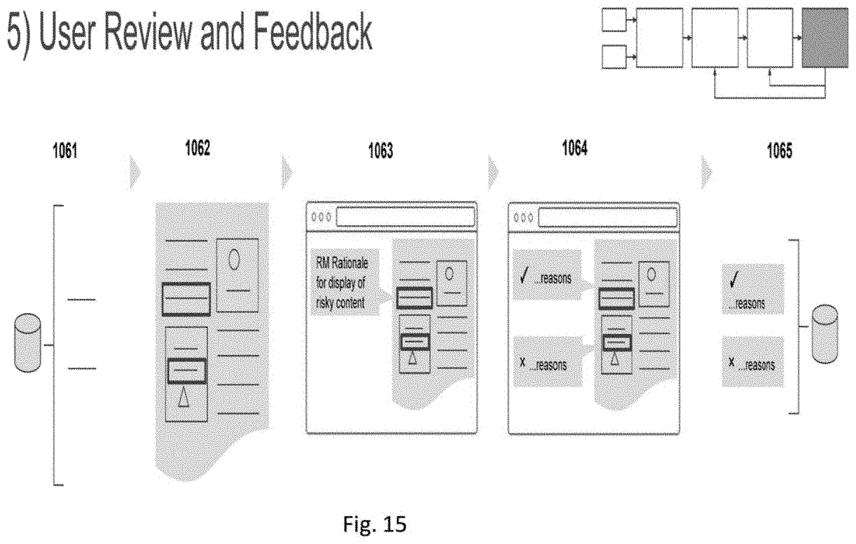

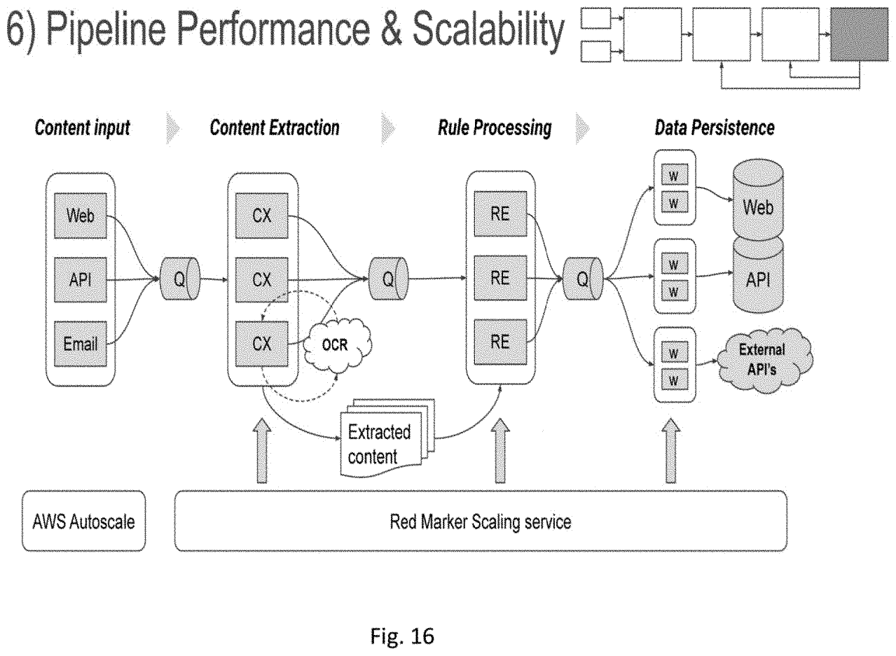

FIGS. 8A and 8B illustrate an embodiment for generating new rules or detection data for storage in at least one database. At least one data set from a database comprising at least one user feedback data set 802 is cleansed, either manually or automatically by the system 804. Preferably, numerous data sets, preferably hundreds or thousands of data sets or data samples, are cleansed for anomalies, corruption or other discrepancies. Manually cleansing will require input from at least one user, preferably an expert user or expert committee. If required, the cleansed data 806 is then de-identified 808 such that at least one metadata set is removed from the data, such as an author or company associated with the data set. The de-identified data 810 is then allocated at random 815 to the test set database 820 and the test harness database 825 for testing. In another embodiment, the de-identified data is allocated based on pre-defined logic between the test set database and the test harness database for testing.

A test can be run 830 to determine whether the training samples can be used for training the system. Optionally, rules or attributes may be manually assigned by at least one user for testing 835. A sample data set may be added to existing models of the system 840 and a test of the existing model/s can be conducted 841 against the test set database and a further test of the existing model/s 842 can be conducted against the test harness database 825.

Identification of additional filters 845 may then be checked. Updated terms can be checked against the test set database 846 and then tested the test harness database 847. A new model may be built 850 by the system and the new model also tested against the test set database 851 and the test harness database 852.

The training samples can then be used to generate potential new filters for the system 855. The proposed new samples may be tested against the test set database 856 and the test harness database 857. The system can then analyse the training samples 860 and form one or more clusters 861. A new model may then be generated 865 and tested against the test set database and the one or more clusters 866 and subsequently tested against the test harness database 867. The training data may then be used to develop at least one new proposed filter 870 and at least one proposed new filter can be tested against the test set database 871 and the test harness database 872. Each of the tested data sets 841, 842, 846, 847, 851, 852, 856, 857, 861, 866, 867, 871 and 872, can be forwarded to continue testing 890 and form a new data sample to test 891 which may then be forwarded to be cleansed 804.

Assessing performance of the modified and/or new models and/or filters may then be conducted 875, and then recommendations for rules and/or detection changes can be made by the system or an expert user 880. The recommendations can be automatically approved 881 by the system and forward to at least one of the detection database 887 and/or the rule database 888. A report with the results of the testing 885 can be forward to at least one user. The at least one user may then manually approve the recommendations or changes 886 or may override automatic approvals to the rules or detection methods of the system. The manually approved recommendations can then be forwarded to at least one of the detection database or the rule database. Continued testing can be conducted after a report is issued 890. The above process may generate at least one new or modified rule and/or attribute for use with the system.

Although the invention has been described with reference to specific examples, it will be appreciated by those skilled in the art that the invention may be embodied in many other forms, in keeping with the broad principles and the spirit of the invention described herein.

One of the biggest breakthroughs required for achieving any level of artificial intelligence is to have machines which can process text data. The difficulty in the present process is that natural language, although governed by grammar rules, can be unstructured. Typical deterministic processes cannot handle natural language efficiently. Although it is known that natural language needs to be handled by a stochastic process, the operation is usually kept inside a black-box. Many of these processes involve an artificial neural network to learn the language pattern. However, such a process requires a huge amount of processing power and is slow.

In one embodiment of the present invention as shown in FIG. 9, there is provided a natural language processing method 1010 to enable a mathematical processor to handle and understand natural language by
1. Marking down the contents of a text or conversation in Step 1011
2. Subjecting the marked down contents into pre-processing in Step 1012. This will include removing noises, such as extra space, punctuations, detecting misspelling, and tokenization, etc.
3. Then the processor will carry out termlist detection in Step 1013, by passing the terms in the contents and matching them with the termlist.
4. Then, the processor will carry out the classification function based on a dynamically generated model definition in Step 1014. The terms will be group into a different classification based on a model definition.
5. The processor will then cycle through each of the classifications and subjected the terms in each of the classifications with a set of logic rules in Step 1015. Each classification will have its own set of rules. As such, the set of logical rules a term is subjected is determined by the classification of the term rather than the term itself.
   The processor will check whether a rule logic or logical rule is triggered based on the following numerical algorithm or numerical analysis rather than simply comparing the term with other pre-defined terms which is done in the classification stage.
   A rule (γ) consists of a set of termlists and is a function of document, sentences, and termlists.

γ=f(d,s,t)
A rule is triggered if a compliance breach is detected. So, to codify this into a quantity determinable by a process, identification of risk (R) happens based on the number of rules triggered. The processor hence will allocate a memory registered to store the count of rules triggered. The processor will determine at the end of the content processing whether the number digital signal store in the memory over a predetermined or dynamically generated threshold or reference number based on the process below.

R=Σᵢ₌₁^{F}γj, wherein F is the number of rule fired
to be stored in a memory
register allocated by the processor.
In one embodiment, the definition of classification model includes logistic regression as presented by the following algorithm.

$$\begin{matrix}{h}_{θ} ( R ) = sigmoid ( y ) \\ = \frac{1}{1 + {e}^{- y}} \\ = \frac{1}{1 + {e}^{- ( {β}_{0} + {β}_{1} R )}}\end{matrix}$$

Then, the processor is able to determine the cost function on the basis of the above hypothesis function.

$$cost ( {h}_{θ} ( R ) , y ) = \{ \begin{matrix}- log {h}_{θ} ( R ) , & y = 1 \\ - log ( 1 - {h}_{θ} ( R ) ) , & y = 0\end{matrix}$$

In order to increase the efficiency of the process, the above cost function is encoded into the following process.

$$J ( θ ) = \frac{- 1}{m} {\sum }_{i = 1}^{m} [ {y}^{( i )} log {h}_{θ} ( {R}_{i} ) + ( 1 - {y}^{( i )} ) log ( 1 - {h}_{θ} ( {R}^{i} ) ) ]$$

6. Using the numerical results of the logical rules, the processor will train the classifier or dynamically adjusting the model definition for the classification function in the classifier training step in Step 1016. In one embodiment, the training comprises a grid search for the best parameters.
7. After the training, the processor will then carry out validation and optimization in Step 1017.
   The processor is able to train the model and keep optimizing using gradient descent to minimize the cost function.

$$min J ( θ ) \text{:} {θ}_{j} ← {θ}_{j} - ∝ {\sum }_{i - 1}^{m} ( {h}_{θ} ( {R}^{( i )} ) - {y}^{( i )} ) \cdot {R}_{j}^{( i )}$$

As such, the training process is simplified into a minimization of the cost function which can be determined efficiently with a local numerical processor.
8. Then, the result of the optimization can be generated numerically in Step 1018.
9. The result is then fed back to the optimization function using gradient descent to minimize the cost function in Step 1019.
10. The model definition of the classification function is then adjusted accordingly in Step 1020.

In an embodiment of the present invention, there is provided a process as shown in FIG. 9 enabling an electronic system to analyse natural language and present the analytical result into a quantified abstract concept, comprising the steps of:
Receiving digital data of a document and load the digital data into a block of random access memory and/or persistent memory in Step 1021;
Then, the processor extracts the contents of the digital data in Step 1022, a list of terms is extracted from the contents and stored in a data model structure;
In Step 1023, the contents are then subjected to the rules;
In Step 1024, the processor then conducted machine learning;
In Step 1025, the processor updates the rules and the machine learning algorithm with user review and feedback.

Referring to FIG. 10, the system carrying out the process of the present invention can be a general computer system or smart device, an embedded processor dedicated to language processing or voice recognition, or an embedded processor for a consumer device such as a scanner. The system is preferably connected to a network and able to receive remote digital data as shown in FIG. 11. The digital data can be an image, voice data, a document file in various formats, an email, PowerPoint document, Websites (HTML, CSS). These digital data can be upload from a terminal, from email, from keylogging, or hand gesture. In one embodiment, the system receives digital data from a voice recording device transcribing the speech into a document. In another embodiment, the system sends out agent application fetching data from the Internet. The input digital data can be a complete document, or a stream of continuous data.

Once the system received the digital data, it will convert the digital data into a uniform format, such as portable document format. The digital data in the form of portable document format (PDF) file will be stored in random access memory or persistent memory for future processing.

Reference is now made to FIG. 12, where the extraction process of Step 1022 is discussed in more detail. The portable document format file created in Step 1031 may contain a combination of metadata, such as comments, font, text style and format, texts, formula, links, references, and images, each of which may also include text. The processor will extract images from the file in an Extract Images Step in Step 1032. These images will be subjected to optical character recognition (OCR) process to identify any textual contents in an OCR Text Step in Step 1033. The textual contents are then added back (sandwiched) into the portable document format file in the location of the original image to form a new document with additional data for analysis in an Embed Text on PDF Step in Step 1034. In an Extract Text Step, the text is then extracted from the resulted PDF file such that the locations of the text from the images relative to text from the PDF are preserved in Step 1035. The text is then stored along with metadata, such as the two-dimensional coordinate or position of the text on the page and font style of the text in the Structure Text Step in Step 1036.

FIG. 13 shows how the contents of the digital data are subject to logical rules. In one preferred embodiment of the present invention, the processor retrieves the text and meta data from the storage in Step 1041 and passes to the classifier in Step 1042. The processor then calculates the relationships of the text and meta data relative to the frequency and location in the digital data in Step 1043. The processor then passes the text and meta data through a set of logic rules in Step 1044. In one embodiment, the logic rules will take into the consideration of the relationships calculated to generate a result. The result can be a form of indicator as to whether a logic rule has been triggered. The processor then sends the analysis to display in Step 1045. In one embodiment, the processor sends the analyzed data into a presentation module. The presentation module is adapted to realize the type of data and present the data into different kinds of charts and graphs, such as bar chart, pie chart, bubble chart, tree map, Voronoi diagram, etc. The data will be fed back to the system for testing and validation in 1046.

After processing a digital data file or a stream of digital data (typically a document or a record of conversation), the processor will store the data into a persistent data storage. The data will also be piped to improve the classification and logic rule through machine learning.

The machine learning step is illustrated in FIG. 14. The system will receive the text and the meta data of an electronic document from data storage in Step 1051. The text is converted into tokens by parsing the text through a natural language processing engine.

After the user is satisfied with the input data and configures the training parameters, the process starts the training process in Step 1052. In this Step 1052, the machine learning models are trained by using the extracted text that was stored during the context extraction phrase in Step 1022. The text is utilized to obtain various features to train the model. In one embodiment, the training process involves a numerical regression of the encoded data and optimization.

The system will then allow the user to validate the trained system with the current data in Step 1053. The models obtained in the training Step 1052 are validated by employing a cross validation method.

The user may then input new data to test the trained system in Step 1054. The validated machine learning model is tested on the held-out data to determine the final accuracy of the models. If internal accuracy thresholds are met, the model is deployed in the next step.

When the user is satisfied with the training system, the new parameters can be deployed to the live system in Step 1055. In this Step 1055, the validated and tested models are deployed to the cloud service.

The live system will integrate new parameters into the classification and rules logic in order to improve the accuracy of the live system in Step 1056. In this step, the deployed models are integrated with the rules workflow.

The system also provides and displays an interface for a user to provide user review and feedback as shown in FIG. 15.

The process will load and display the portable document format file of the digital data in Step 1061. Portable document format files are retrieved from storage and include the coordinates where they occur on the document.

The processor will highlight the content data that trigger the rules in Step 1062. Highlight displays are added to the portable document format file as annotated comments in accordance with the portable document format standard and rules.

The processor will display the markers referencing the highlighted data in Step 1063. Users can see markers referencing displays (annotated comments), including the rationale of why it is shown.

The system interface will allow users to provide feedback to the highlighted contents and the correctness of the markers in Step 1064 and Step 1065. The system will store the user feedback in a persistent storage. Users can agree or disagree with the highlighted results and the annotated comments. The results are stored so they can be used to improve models and rules.

FIG. 16 shows a schematic diagram of the pipeline performance and scalability of a system in accordance with an embodiment of the present invention.

In one embodiment of the present invention, the system is designed to provide a pipeline performance and scalability, Documents are uploaded via several methods running by individual software agents which autoscale depending on demand.

In one embodiment, the system provides a scheduling module having a “scaling service” monitors queue (Q) length and starts additional Content Extraction (CX) instances depending on demand. The schedule module is adapted to folk threads of Content Extraction (CX) instances and allocate to processor cores. In one embodiment, the schedule module comprises multiple queues and buffers to provide quality of service functionality. The CX instance is adapted to carry out the extraction process of Step 1022.

The schedule module is adapted to folk threads of Rules Engine (RE) and Machine Learning instances. The Rule Engine (RE) instance is adapted to executing the logic rules in Step 1023; and the Machine Learning instance is adapted to conducted machine learning 1024. The “scaling service” monitors queue length and starts additional Rules Engine (RE) and Machine Learning instances depending on demand.

The schedule module is adapted folk pools of import workers (w) or agents for each destination and they are managed by the scaling service by monitoring the number of tasks in the queue. Additional workers are added on demand. The import workers (w) or agents are adapted to store the data into persistent memory storage. The schedule module is adapted to ensure the integrity of the data storage process and resolve critical sections.

The present invention and the described preferred embodiments specifically include at least one feature that is industrial applicable.

What is claimed is:

1. A system for a computer useable medium, the system having a set of executable code comprising:
a first set of computer program code adapted to receive at least a portion of a document comprising at least one classifiable distinct marker;
a second set of computer program code adapted to analyse the distinct marker and assign a classifier thereto; and
a third set of computer program code adapted to assess the potential risk of the distinct marker and calculate a first risk value associated with the distinct marker as it relates to the classifier and display the first risk value to a user of the system.

2. The system of claim 1, wherein the first risk value is determined in part by at least one rule associated with the classifier.

3. The system of claim 1, wherein the first risk value is determined in part by the classifier associated with the distinct marker and whether the information is one of personal advice, general advice, a general statement, contains complex terms and jargon, or a specialized professional statement.

4. The system of claim 1, wherein a fourth set of computer program code is adapted to process the portion of the document to identify at least one of embedded metadata or other descriptors, process text, words, phrases and replace personal information contained therein with generic or randomized personal information.

5. The system of claim 1, wherein the document is selected from the group of: a newspaper article, a social media post, a video recording, audio recording, a professional document, a letter, an email, a record, a register, a report, a log, a chronicle, a file, an advertisement, an internet webpage, a forum post, instant messaging, an archive or a catalogue.

6. The system of claim 1, wherein the distinct markers of the document are uploaded to a knowledge base of the system.

7. The system of claim 1, wherein the system determines whether the first risk value of a distinct marker is acceptable or unacceptable, such that if an unacceptable first risk value is calculated the system issues an alert.

8. The system of claim 7, wherein the alert provides at least one suggestion to a user of the system to amend at least one distinct marker such that a second risk value can be calculated for the at least one distinct marker to modify the potential risk value if an amendment is made to at least one distinct marker.

9. The system of claim 1, wherein the portion of the document comprises at least a first distinct marker and a second distinct marker, each of the first and the second distinct markers having an independent risk value assigned thereto, and wherein the first and the second distinct markers are associated by the system as a couple marker.

10. The system of claim 9, wherein the couple marker has a couple risk value which is determined in part by the independent risk values of the first and second distinct markers.
